(19) United States
(12) Patent Application Publication
(10) Pub. No.: US 2023/0360370 A1
(43) Pub. Date: Nov. 9, 2023

(54) NEURAL NETWORK ARCHITECTURES FOR INVARIANT OBJECT REPRESENTATION AND CLASSIFICATION USING LOCAL HEBBIAN RULE-BASED UPDATES

(71) Applicant: STOWERS INSTITUTE FOR MEDICAL RESEARCH, KANSAS CITY, MO (US)

(72) Inventors: Congrong Yu, Leawood, KS (US); Rishabh Raj, Kansas City, MO (US)

(21) Appl. No.: 18/343,557

(22) Filed: Jun. 28, 2023

Related U.S. Application Data
(63) Continuation of application No. PCT/US23/65456, filed on Apr. 6, 2023.
(60) Provisional application No. 63/328,063, filed on Apr. 6, 2022.
(60) Provisional application No. 63/480,675, filed on Jan. 19, 2023.

(51) Int. Cl. G06V 10/77; G06V 10/82

(52) U.S. Cl. CPC G06V 10/7715; G06V 10/82

(57) ABSTRACT

This disclosure relates to improved systems, methods, and techniques for constructing and employing neural network architectures to solve computer vision and other problems. The neural network architectures can have two or three layers with all nodes in the first layer connected to all nodes in the second layer. The nodes in the second layer can be connected to each other. The weights or values of the various connections between these nodes in the first two layers can also be updated between the processing of inputs to the neural network architectures. These neural network architectures do not require extensive training and can learn continuously. Other embodiments are disclosed herein as well.

### GOVERNMENT FUNDING

This invention was made with government support under grant number NIH RO1 DC014701 awarded by the National Institutes of Health. The government has certain rights in the invention.

### CROSS-REFERENCE TO RELATED APPLICATIONS

This application is a continuation of International Patent Application No. PCT/US23/65456 filed on April 6, 2023, which claims benefit of, and priority to U.S. Provisional Patent Application No. 63/328,063 filed on Apr. 6, 2022 and U.S. Provisional Patent Application No. 63/480,675 filed on Jan. 19, 2023. The contents of the above-identified applications are herein incorporated by reference in their entireties.

### TECHNICAL FIELD

This disclosure is related to improved machine learning configurations and techniques for invariant object representation and classification. In certain embodiments, the configurations and techniques described herein can be executed to enhance various computer vision functions including, but not limited to, functions involving object detection, object classification, and/or instance segmentation.

### BACKGROUND

Computer vision systems can be configured to perform various functions, such as those that involve object detection, object classification, and/or instance segmentation. These computer vision functions can be applied in many different contexts, such as facial recognition, medical image analysis, smart surveillance, and/or image analysis tasks.

Computer vision systems must account for a variety of technical problems to accurately implement the aforementioned computer vision functions. For example, one technical problem relates to accurately extracting features from input images. This can be particularly difficult in scenarios in which the objects (e.g., facial objects) included in the input images are partially hidden or heavily occluded, and/or degraded by noise, poor illumination, and/or uneven lighting. Other factors that can hinder feature extraction can be attributed to variations in camera angles, motion, perspective, poses, and object appearances (e.g., variations in facial expressions) across different images.

Other technical difficulties involve designing a computer vision system that is able to efficiently extract features from images. Many feature extraction mechanisms are computationally expensive and resource intensive. Moreover, they are often built upon deep learning models that include multiple complex processing stages, and which require extensive training datasets to be precisely labeled in order to facilitate supervised training.

Frameworks for performing feature extraction suffer from a variety of other shortcomings as well. For instance, with respect to frameworks that use blind source separation techniques, these frameworks fail to take into account the informativeness of features based on their relative abundance. Though a framework set to capture informative features does not need to know the exact occurrence frequency of objects, it should take the relative abundance of features into account. However, blind source separation and other related techniques are not capable of doing so.

Consider the scenario in which blind source separation techniques utilize a dictionary to represent features. Changing the input matrix to include multiple occurrences of the same input does not change the dictionary's nature. The multiple occurrences lead to repeated representations with the same level of sparsity and reconstruction error. Therefore, the dictionary and the representations remain similar to those obtained while considering each input only once. In other words, there is no constraint on the dictionary that forces it to change according to the relative occurrence of inputs. Consequently, blind source separation approaches fail to utilize an environment's statistical properties to improve performance.

Frameworks that utilize sparse non-negative matrix factorization for feature extraction also include drawbacks. Though these frameworks can successfully generate invariant and efficient representations of inputs in some scenarios, the sparse non-negative matrix factorization-based approach used in obtaining the features is not always technologically plausible or feasible in its current form. In some cases, the limitations arise because the algorithm utilized by these frameworks does not incorporate the physiological constraints faced by a biological system.

Furthermore, in certain feature extraction approaches, capturing the most informative structures from inputs is often a different process than obtaining input representations. As such, any network that accomplishes both generally incorporates two separate structures for accomplishing these two goals. Many of these limitations can be ameliorated or overcome when examining the mathematical algorithms underpinning these approaches from the standpoint of the physiological constraints facing biological systems that can process visual data and exhibit learning. Several aspects of biological systems that are desirable in any sensory coding process are absent in known approaches to sensory processing.

Another drawback of existing techniques is that they do not accurately mimic processes of biological systems. An essential aspect of a biological system is its development. Organisms grow and develop with time, reach maturation, and eventually die. During their lives, they experience their surroundings and learn to adapt to them. From the perspective of sensory processing, this constitutes a continuous period of sensory experiences, and it allows the organisms to learn and re-learn sensory events. As a corollary, a biological system does not encounter all the events and stimuli to which it adapts at one point it time. It gradually discovers these events, determines their relevance with experience, and then conforms accordingly to represent them.

Furthermore, biological systems do not have separate “circuits” to capture features and generate representations. The same structure adapts to a set of inputs and represents them. Moreover, the input representations are expected to guide the process of adaptation. In contrast, existing feature extraction approaches typically fail to recapitulate these critical sensory processing aspects and do not integrate the two processes.

Animals, even ones with relatively simple brains, are able to recognize deformed, corrupted, or occluded objects. Animal intelligence evolves from the ground up, and the ability to learn, represent, and generalize these signals quickly and consistently under variegated circumstances is key to animals' ability to survive a constantly changing environment. Despite enormous variations in cognitive sophistication, an astonishing fact is that cognitive functions are based on local computations and synaptic learning rules. Modifications in the synaptic strengths are instructed only by the activities of pre-and post-synaptic neurons. They are indifferent to changes in other parts of the brain, yet the brain, whether simple or complex, can learn to extract environmental signals from a small number of examples, generalize them, and recognize object identity and class to drive appropriate behavioral responses. Despite recent advancements in understanding biological neural systems, it is not known how the brain can use the local learning rules to generate representations of objects invariant to signal corruption and variations in size, location, and perspective.

Inspired by early studies of the visual hierarchy, known artificial neural network models and deep learning variants, relying on convolutions and serial integration of features, have mimicked cognitive functions and can show remarkable performance. Although these models have been suggested to recapitulate computations taking place in the brain, they operate in fundamentally different ways from biological nervous systems. Designed to address specific engineering problems, the models typically rely on a learning process that minimizes discrepancy (or error or a cost function) between the desired output and the actual output. This process requires the networks to “know” predetermined sets of inputs and their corresponding outcomes, and detected mismatches can be propagated throughout the network to update connection weights to minimize the error. While these goal-directed updates and supervised training techniques make these neural networks exceptionally accurate in performing specific tasks, this comes at various costs. For example, these networks do not have the ability to learn continuously in the same manner as biological systems. Rather, upon completion of training, the updated connection weights are “frozen” and do not change further. Additionally, exposition to new tasks can lead to catastrophic forgetting. Training on specific examples does not generalize well beyond its training data and also renders the networks vulnerable to adversarial attacks. To improve performance and robustness, numerous layers and large amounts of training data are required.

In contrast, biological brains do not know specific inputs a priori. They learn without instructions or labels, and there is no natural mechanism to back-propagate errors. Organic systems are also constantly updated through experience and, in contrast to existing neural networks, they are remarkably robust against adversarial attacks. To capture the advantages inherent in biological systems, artificial network models should use local learning rules to achieve global success in feature capturing, representing and classifying objects. This approach has not been implemented to date.

### BRIEF DESCRIPTION OF DRAWINGS/ATTACHMENTS

To facilitate further description of the embodiments, the following drawings are provided, in which like references are intended to refer to like or corresponding parts, and in which:

FIG. 1A is a diagram of an exemplary system for generating image analysis in accordance with certain embodiments;

FIG. 1B is a block diagram demonstrating exemplary features of a computer vision system in accordance with certain embodiments.

FIG. 2 is a diagram of an exemplary neural network architecture in accordance with certain embodiments;

FIG. 3 is a diagram illustrating how inputs in an input sequence can be captured in the representation layer for a neural network architecture in accordance with certain embodiments;

FIG. 4 is a diagram illustrating how inputs in an input sequence that are corrupted can be learned by a neural network architecture in accordance with certain embodiments;

FIGS. 5A-5C are diagrams illustrating how characteristics of an object can be captured in the output of the representation layer for an neural network architecture in accordance with certain embodiments;

FIG. 6 is a diagram of an exemplary neural network architecture in accordance with certain embodiments;

FIGS. 7A-7B are diagrams illustrating characteristics of an object that are captured in the output for a neural network architecture in accordance with certain embodiments; and

FIG. 8 is a flowchart illustrating an exemplary method for a neural network architecture in accordance with certain embodiments.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

The terms “left,” “right,” “front,” “rear,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

### DETAILED DESCRIPTION OF EXEMPLARY EMBODIMENTS

The present disclosure relates to systems, methods, apparatuses, computer program products, and techniques for providing a neural network architecture that leverages local learning rules and a shallow, bi-layer neural network architecture to extract or generate robust, invariant object representations from objects included in images. In certain embodiments, the neural network architecture can be trained to generate invariant responses to image inputs corrupted in various ways. The learning process does not require any labeling of the training set or pre-determined outcomes, and eliminates the need for large training datasets during the learning process. Instead, the neural network architecture can generate the invariant object representations using only local learning rules, and without requiring backpropagation during the learning process or resorting to using reconstruction error or credit assignment. The enhanced object representations generated by the neural network architecture can be utilized to improve performance of various computer vision functions, for example, such as those which may involve object detection, object classification, object representation, object segmentation, or the like.

To overcome the limitations of known feature extraction techniques, a biologically-inspired shallow bi-layered, redundancy capturing artificial neural network (ANN), is provided that learns comprehensive structures from objects in an experience dependent manner. In certain embodiments, the ANN comprises nodes that can be configured to extract unique input structures and efficiently represent inputs. In some scenarios, a single ANN can incorporate the functionality of both blind source separation and sparse recovery techniques. The ANN can include a modified Hopfield network that implements learning rules that allow redundancy capturing. In certain embodiments, the ANN includes biased connectivity and stochastic gradient descent-type learning to sequentially identify multiple inputs without catastrophic forgetting. The ANN can capture structures that uniquely identify individual objects and produces sparse, de-correlated representations that are robust against various forms of input corruption. Notably, the ANN can learn from various corrupted input forms to extract uncorrupted features in an unsupervised manner, separate identity and rotation information from different views of rotating 3D objects, and can produce cells tuned to different object orientations under unsupervised conditions. The ANN can learn to represent the initial sets of data (such as training set data) really well, but the ANN can also perform well for images similar to those included in an initial (or training) data set but that are not identical. In such scenarios, the ANN can adapt to the new images and represent them more sparsely and more robustly because it can employ continuous learning.

In certain embodiments, the ANN includes a first layer of input nodes that can be connected in an all-to-all configuration with a second layer of representation nodes. Inhibitory recurrent connections among the representation nodes in the second layer provide negative input values and also can be connected in an all-to-all configuration. The input nodes can be configured to detect patterns in an input dataset, and project these patterns to the representation nodes in the second layer. The sparsity of the representations from the representation nodes of the ANN is generated by the inhibitory recurrent connections between the nodes in the representation layer. These inhibitory connections differ from the connections between the second layer nodes in a traditional Hopfield network, which are excitatory recurrent connections. Establishing a connection between an input node and a representation node enables the representation node to learn information related to features that are extracted by the input node.

In the ANN, the capturing of the informative structures can be reflected in the tuning properties of the representation nodes (or nodes of the second layer). The tuning properties are a measure of how well the ANN has adapted to extracting features (or objects) from the images input into it (such as through the updating of weights). The tuning properties of the representation nodes can be determined by how they are connected to the early-stage nodes (such as the input nodes) in the sensory pathway (signal path). Therefore, the adaptation to inputs can pertain to changes in the connections of the ANN.

The ANN more accurately mimics real-world biological cognitive processes in comparison to traditional approaches to neural network design. As mentioned above, many traditional artificial neural networks designed to represent objects utilize an optimization process where discrepancies between the actual and desired outputs are reduced by updating the network connections through mechanisms such as error backpropagation. This approach requires individual connections at all levels of the artificial neural network to be sensitive to errors found in the later stages of the network. However, learning in biological nervous systems is known to occur locally, depending on pre-synaptic and post-synaptic activities. Further, traditional techniques require the artificial neural network to “know” the correct outcome for certain sets of inputs, which is not required by biological neural networks. Moreover, while many existing artificial neural networks require a distinct training phase, biological neural networks are constantly learning (that is, weights of the connections between the various neurons/nodes are updated constantly throughout the life of the neural network). These aspects of biological neural networks make them less susceptible to adversarial attacks than many preexisting artificial neural networks, regardless of their complexity. The ANNs described throughout this disclosure are modeled to more accurately mimic these and other aspects of biological neural networks. Further, like biological systems, representations in the ANN can be non-negative.

In certain embodiments, the ANNs described herein dynamically update or change tuning properties for the representation nodes as the connections of the nodes change. Appropriate changes in the connectivity can guide the nodes to be tuned to the most informative structures. As a connection between two nodes can be both excitatory and inhibitory, the changes in these connections can similarly be of either nature and, therefore, the updates in different connections can result in differing positive or negative signs. Such updates may appear contradictory to the non-negativity constraint placed on the values of the nodes that helps capture informative structures. However, though the connectivity changes can be bidirectional, the inhibitory connections may only reduce activities of the nodes without pushing the value of any node below zero. In this setting, the ANN may not subtract the tuning properties of the nodes from one another. Thus, the non-negativity constraint can be satisfied even though the nodes receive both excitatory and inhibitory inputs.

Further, the ANN can extract unique features from inputs in an experience-dependent manner and generate sparse, efficient representations of the inputs based on such structures. Unlike neural networks based on traditional Hopfield networks, the ANN described throughout this disclosure can be designed to be adaptive. The connectivity between the input layer and the representation layer can change based on the input to optimize its representation. Updating the connectivity of the ANN can be accomplished by using a stochastic gradient descent (SGD) type approach. Using this SGD-like approach, the ANN can slowly adapt to new inputs in a manner that does not affects its adaptation to other previous inputs. With repeated encounters to inputs, the ANN can adapt to all different inputs.

Unlike in certain methods, such as the matrix factorization approach, where efficiency decreases with the number of inputs, the design of the ANN described herein allows for an increase in efficiency with both repeated encounters and the number of inputs. Adapting to a larger number of inputs can cause the ANN to contain more information about the inputs, and accommodating more information in the ANN can lead to proper utilization of the ANN's capacity and increases in efficiency.

In certain embodiments, the bi-layer neural network architecture of the ANN can be extended or connected to a classification layer to create a classification network. Whereas the discrimination (or representation) layer of the bi-layer neural network accentuates differences between different objects received as inputs by the neural network, the classification layer identifies shared features between the different objects in the input. Nodes in the classification layer may be subject to mutual excitation from other nodes in the classification layer and general inhibition. In some embodiments, these nodes can be connected in a one-to-one fashion to nodes in the discrimination layer in an excitatory manner and to nodes in the input layer in an inhibitory manner. These design concepts are modeled after observed configurations in sensory cortices of vertebrate brains. As explained in further detail below, the design of the classification network can enable it to classify similar objects and identify the same object from different perspectives, sizes, and/or positions. It further enables the classification network to classify representations of the same object (varied by size, perspective, etc.) even if it has not yet processed or experienced the particular representation.

The classification network has the additional advantages over traditional approaches of being fully interpretable (a so-called white box) and of not being subject to catastrophic forgetting, which is a commonly observed phenomenon in traditional approaches and results in the neural network forgetting how to perform one task after it is trained on another task. The classification network performs its analysis on inputs in a manner that is both efficient and robust.

The identity of an object is embedded in the structural relationships among its features and the neural network architectures of this disclosure can utilize these relationships, or dependencies, to encode object identity. Moreover, as explained in further detail below, because the neural network architecture maximally captures these dependencies, it is able to identify the presence of an object without accurate details of the input patterns and to generate or extract invariant representations.

The technologies discussed herein can be used in a variety of different contexts and environments. One useful application of these technologies is in the context of computer vision, which can be applied across a wide variety of different applications. For example, the technologies disclosed herein may be integrated into any application, device, or system that can benefit from using the object representations described herein.

One exemplary application of these technologies can be applied in the context of facial recognition. Another useful application of these technologies is in the context of surveillance systems (e.g., at security checkpoints). Another useful application of these technologies is in the context of scene analysis applications (e.g., which may be used in automated, unmanned, and/or autonomous vehicles that rely on automated, unmanned, and/or autonomous systems to control the vehicles). Another useful application of these technologies is in the context of intelligent or automated traffic control systems. Another useful application of these technologies is in image editing applications. Another useful application of these technologies is in the context of satellite imaging systems. Additional useful applications can include quality control systems (e.g., industrial sample checks and industrial flaw detection), agricultural analysis systems, and medical analysis systems (e.g., for both human and animal applications).

The technologies discussed herein can also be applied to many other contexts as well. For example, they can be used to process and/or analyze DNA and RNA sequences, auditory data, sensory data, or data collected from other sources. In these contexts, the neural network architecture can identify, categorize, or extract other information from the inputted data related to objects in that data, which may be certain patterns or other features of the data. The neural network architecture can generally perform the same functions related to extracting representations and/or classifying portions of the inputted data as it can with visual images. The data to be analyzed and/or processed by the neural network architecture can be pre-processed in some way, such as by converting it into pixels to form an image to be input into the neural network architecture. Other preprocessing steps, such as scaling and/or applying a wavelet or Fourier transform, can be applied to inputs of all types.

The embodiments described in this disclosure can be combined in various ways. Any aspect or feature that is described for one embodiment can be incorporated to any other embodiment mentioned in this disclosure. Moreover, any of the embodiments described herein may be hardware-based, may be software-based, or, preferably, may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software.

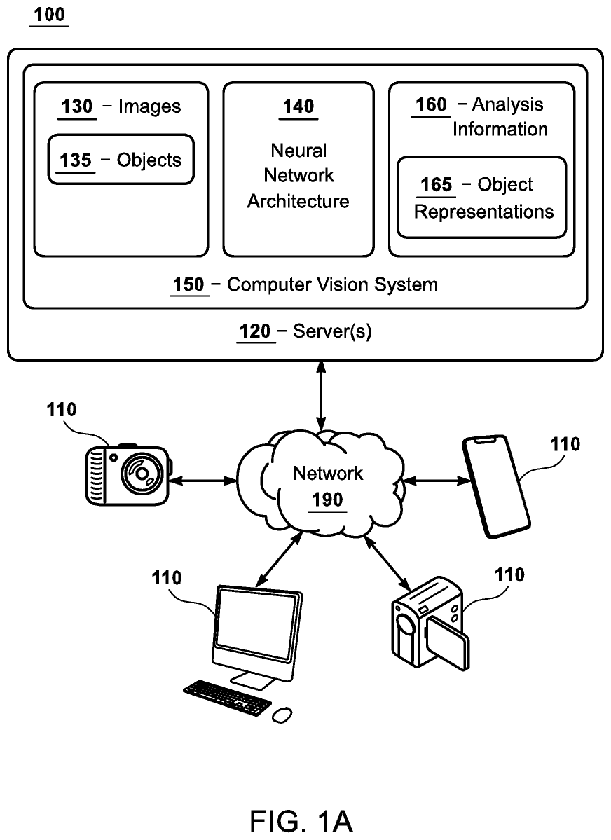

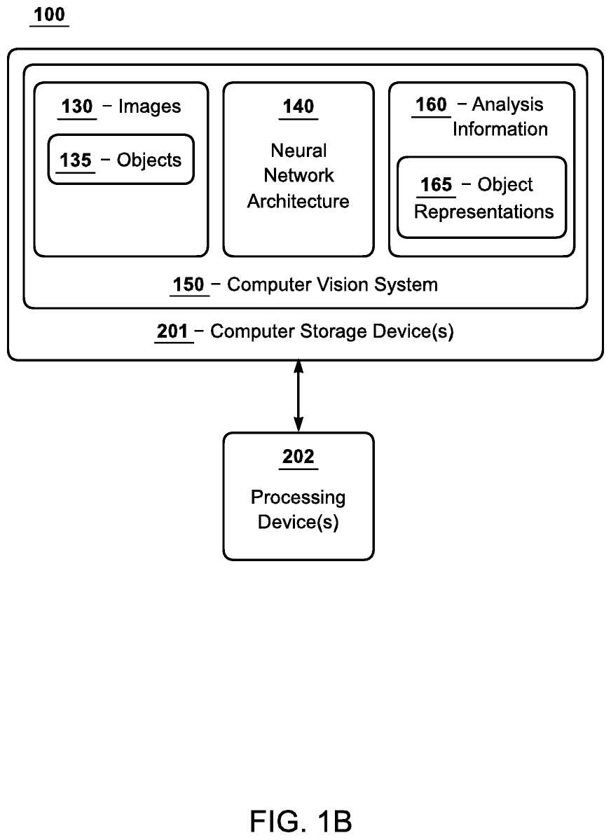

FIG. 1A is a diagram of an exemplary system 100 in accordance with certain embodiments. FIG. 1B is a diagram illustrating exemplary features and/or functions associated with a computer vision system 150. FIGS. 1A and 1B are discussed jointly below.

The system 100 comprises one or more computing devices 110 and one or more servers 120 that are in communication over a network 190. A computer vision system 150 is stored on, and executed by, the one or more servers 120. The network 190 may represent any type of communication network, e.g., such as one that comprises a local area network (e.g., a Wi-Fi network), a personal area network (e.g., a Bluetooth network), a wide area network, an intranet, the Internet, a cellular network, a television network, and/or other types of networks.

All the components illustrated in FIGS. 1A and 1B, including the computing devices 110, servers 120, and computer vision system 150 can be configured to communicate directly with each other and/or over the network 190 via wired or wireless communication links, or a combination of the two. Each of the computing devices 110, servers 120, and computer vision system 150 can also be equipped with one or more communication devices, one or more computer storage devices 201, and one or more processing devices 202 (e.g., central processing units) that are capable of executing computer program instructions.

The one or more computer storage devices 201 may include (i) non-volatile memory, such as, for example, read only memory (ROM) and/or (ii) volatile memory, such as, for example, random access memory (RAM). The non-volatile memory may be removable and/or non-removable non-volatile memory. Meanwhile, RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the computer storage devices 201 may be physical, non-transitory mediums. The one or more computer storage devices 201 can store instructions associated with executing the functions perform by the computer vision system 150.

The one or more processing devices 202 may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions. The one or more processing devices 202 can be configured to execute any computer program instructions that are stored or included on the one or more computer storage devices including, but not limited to, instructions associated with executing the functions perform by the computer vision system 150.

Each of the one or more communication devices can include wired and wireless communication devices and/or interfaces that enable communications using wired and/or wireless communication techniques. Wired and/or wireless communication can be implemented using any one or combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). In certain embodiments, the one or more communication devices additionally, or alternatively, can include one or more modem devices, one or more router devices, one or more access points, and/or one or more mobile hot spots.

In certain embodiments, the computing devices 110 may represent desktop computers, laptop computers, mobile devices (e.g., smart phones, personal digital assistants, tablet devices, vehicular computing devices, or any other device that is mobile in nature), and/or other types of devices. The one or more servers 120 may generally represent any type of computing device, including any of the computing devices 110 mentioned above. In certain embodiments, the one or more servers 120 comprise one or more mainframe computing devices that execute web servers for communicating with the computing devices 110 and other devices over the network 190 (e.g., over the Internet).

In certain embodiments, the computer vision system 150 is stored on, and executed by, the one or more servers 120. The computer vision system 150 can be configured to perform any and all operations associated with analyzing images 130 and/or executing computer vision functions including, but not limited to, functions for performing feature extraction, object detection, object classification, and object segmentation.

The images 130 provided to, and analyzed by, the computer vision system 150 can include any type of image. In certain embodiments, the images 130 can include one or more two-dimensional (2D) images. In certain embodiments, the images 130 may include one or more three-dimensional (3D) images. Further, the images 130 can be created from non-visual data sources by pixelizing (that is converting the non-visual data into an ‘image’ including one or more ‘pixels’ representing portions of the non-visual data), such as DNA or RNA sequences, auditory data, sensory data, and other types of data. The images 130 may be captured in any digital or analog format, and using any color space or color model. The images 130 can be portions excerpted from a video. Exemplary image formats can include, but are not limited to, bitmap (BMP), JPEG (Joint Photographic Experts Group), TIFF (Tagged Image File Format), GIF (Graphics Interchange Format), PNG (Portable Network Graphics), STEP (Standard for the Exchange of Product Data), etc. Exemplary color spaces or models can include, but are not limited to, sRGB (standard Red-Green-Blue), Adobe RGB, gray-scale, etc. Further, in some embodiments, some or all of the images 130 can be preprocessed and/or transformed prior to being analyzed by the computer vision system 150. For example, the images 130 can be split into different color elements and/or processed via a transform, such as a Fourier or wavelet transform. Other preprocessing and transformation operations also can be applied.

The images 130 received by the computer vision system 150 can be captured by any type of camera device. The camera devices can include any devices that include an imaging sensor, camera, or optical device. For example, the camera devices may represent still image cameras, video cameras, and/or other devices that include image/video sensors. The camera device can capture and/or store both visible and invisible spectra including, but not limited to, ultraviolet (UV), infrared (IR), or positron emission tomography (PET), Magnetic resonance imaging (MRI), x-ray, ultrasound, other types of medical and nonmedical imaging. The camera devices also can include devices that comprise imaging sensors, cameras, or optical devices and which are capable of performing other functions unrelated to capturing images. For example, the camera devices can include mobile devices (e.g., smart phones or cell phones), tablet devices, computing devices, desktop computers, etc. The camera devices can be equipped with analog-to-digital (A/D) converters and/or digital-to-analog (D/A) converters based on the configuration or design of the camera devices. In certain embodiments, the computing devices 110 shown in FIG. 1 can include any of the aforementioned camera devices, and other types of camera devices.

Each of the images 130 (or the corresponding scenes captured in the images 130) can include one or more objects 135. Generally speaking, any type of object 135 may be included in an image 130, and the types of objects 135 included in an image 130 can vary greatly. The objects 135 included in an image 130 may correspond to various types of inanimate articles (e.g., vehicles, beds, desks, windows, tools, appliances, industrial equipment, curtains, sporting equipment, fixtures, etc.), living things (e.g., human beings, faces, animals, plants, etc.), structures (e.g., buildings, houses, etc.), symbols (Latin letters of the alphabet, Arabic numerals, Chinese characters, etc.) and/or the like. When the underlying data to be analyzed is not visual in nature (such as DNA or RNA sequences, auditory data captured by microphones or audio sensors, etc.), the objects 135 can include any patterns or features of importance found in the data. The images 130 received by the computer vision system 150 can be provided to the neural network architecture 140 for processing and/or analysis.

Amongst other things, the neural network architecture 140 can extract enhanced or optimized object representations 165 from the images 130. The object representations 165 may represent features, embeddings, encodings, vectors and/or the like, and each object representation 165 may include encoded data that represents and/or identifies one or more objects 135 included in an image 130. In certain embodiments, the neural network architecture 140 can learn patterns presented to it in a sequential manner, and this learned knowledge can be leveraged to optimize the object representations 165 and perform other functions described herein.

The structure or configuration of the neural network architecture 140 can vary. In certain embodiments, the neural network architecture 140 can include one or more recurrent neural networks (RNNs). For example, in some cases, the neural network architecture 140 can include a Hopfield network that has been modified and optimized to perform the tasks described herein. In certain embodiments, the modified Hopfield network is a shallow, bi-layer RNN that comprises a first layer of input nodes (or input neurons) and a second layer of representation nodes (or representation neurons). Each of the representation nodes can be connected to each of the input nodes in an all-to-all configuration, and feedforward weights between the input and representation nodes can be chosen to minimize the chances that two representation nodes are active at the same time. Additionally, the representation nodes can be connected to each other using recurrent connections. In some embodiments, the biased connectivity among the nodes, coupled with a stochastic gradient descent (SGD) based learning mechanism, enable the neural network architecture 140 to sequentially identify multiple inputs without catastrophic forgetting. The biased connectivity and lateral inhibition in the neural network architecture 140 enable the representation nodes to encode structures that uniquely identify individual objects.

In certain embodiments, slow synaptic weight changes allow continuous learning from individual examples. In such embodiments, the slowness (relative to traditional image analysis systems) does not cause disturbances in the overall network connections, but allows specific patterns to be encoded. In some embodiments, there is no normalization step with each learning iteration, which can prevent the production or assignment of negative synaptic weights. Such a result is due to the slow synaptic weight changes and is similar to biological systems (e.g. in animal brains, where synaptic weights never go negative).

In certain embodiments, the number of representation nodes included in the neural network architecture 140 may be proportional to the number of images or objects for which recognition is desired. In such instances, the representational layer may contain approximately the same number of nodes as the number of images to be identified. In some embodiments, there may be 2x or more (up to 10x or more) expansion of the number of nodes from the primary layer to the representation layer. For many applications of the neural network architecture 140, more nodes in each layer yield better results. There is no upper bound on the number of total nodes comprising the neural network architecture 140.

In some embodiments, the neural network architecture 140 can be configured to be adaptive, such that the connectivity between the input layer and the representation layer is permitted to change based on a given input image that is being processed. This dynamic adaptation of the connections between the input layer and the representation layer enables the neural network architecture 140 to optimize the object representations 165 that are generated. The resulting object representations 165 are sparse, and individual nodes of the neural network architecture 140 are de-correlated, thereby leading to efficient coding of the input patterns. Moreover, because the neural network architecture 140 can extract the informative structures from the objects 135 in the images 130, the resulting object representations 165 are robust against various forms of degradation, corruption and occlusion.

Other configurations of the neural network architecture 140 also may be employed. While certain portions of this disclosure describe embodiments in which the neural network architecture 140 includes a modified Hopfield network or RNN, it should be understood that the principles described herein can be applied to various learning models or networks. In some examples, layers of the neural network architecture 140 can be appropriately stacked and/or parallelized in various configurations to form deep neural networks that execute the functions described herein. In certain embodiments where the neural network architecture 140 is stacked, the output of its representation layer or its classification layer (in instances where the neural network architecture 140 includes a third layer), or both, can be used as input to the next neural network(s) (such as another 2- or 3-layer modified Hopfield network). In such embodiments, the input to these later neural networks is derived from the activity from each node of the previous neural network architecture 140 and can be treated as a pixel of input to the next network. In certain embodiments, the neural network architecture 140 can include a classic perceptron as an additional layer that reads class information.

In certain embodiments where the neural network architecture 140 is stacked, the first neural network architecture 140 can be used as a scanning device, which allows a limited number of pixels to cover a larger scene (similar to a biological organism using its eyes to focus on one area of the visual field at a time but synthesize the whole scene). To synthesize the whole scene, the scanned images (or sub-scenes) can be treated as time-invariant even though they are obtained at different points in time.

In one example, the principles described herein can be extended or applied to other types of RNNs that are not specifically mentioned in this disclosure. In another example, the principles described herein can be extended or applied to reinforced learning neural networks. In a further example, the principles described herein can be extended or applied to convolutional neural networks (CNNs).

For example, in certain embodiments, the neural network architecture 140 may additionally, or alternatively, comprise a convolutional neural network (CNN), or a plurality of convolutional neural networks. Each CNN may represent an artificial neural network, and may be configured to analyze images 130 and to execute deep learning functions and/or machine learning functions on the images 130. Each CNN may include a plurality of layers including, but not limited to, one or more input layers, one or more output layers, one or more convolutional layers (e.g., that include learnable filters), one or more ReLU (rectifier linear unit) layers, one or more pooling layers, one or more fully connected layers, one or more normalization layers, etc. The configuration of the CNNs and their corresponding layers can be configured to enable the CNNs to learn and execute various functions for analyzing, interpreting, and understanding the images 130, including any of the functions described in this disclosure.

Regardless of its configuration, the neural network architecture 140 can be trained to extract robust object representations 165 from input images 130. In some embodiments, the neural network architecture 140 also can be trained to utilize the object representations 165 to execute one or more computer vision functions. For example, in some cases, the object representations 165 can be utilized to perform object detection functions, which may include predicting or identifying locations of objects 135 (e.g., using bounding boxes) associated with one or more target classes in the images 130. Additionally, or alternatively, the object representations 165 can be utilized to perform object classification functions (e.g., which may include predicting or determining whether objects 135 in the images 130 belong to one or more target semantic classes and/or predicting or determining labels for the objects 135 in the images 130) and/or instance segmentation functions (e.g., which may include predicting or identifying precise locations of objects 135 in the images 130 with pixel-level accuracy). The neural network architecture 140 can be trained to perform other types of computer vision functions as well.

The neural network architecture 140 of the computer vision system 150 is configured to generate and output analysis information 160 based on an analysis of the images 130. The analysis information 160 for an image 130 can generally include any information or data associated with analyzing, interpreting, understanding, and/or classifying the images 130 and the objects 135 included in the images 130. In certain embodiments, the analysis information 160 can include information or data representing the object representations 165 that are extracted from the input images 130. The analysis information 160 may further include orientation information that indicates an angle of rotation or orientation or position of objects 135 included in the images 130.

Additionally, or alternatively, the analysis information 160 can include information or data that indicates the results of the computer vision functions performed by the neural network architecture 140. For example, the analysis information 160 may include the predictions and/or results associated with performing object detection, object classification, and/or other computer vision functions.

In the exemplary system 100 shown in FIG. 1, the computer vision system 150 may be stored on, and executed by, the one or more servers 120. In other exemplary systems, the computer vision system 150 can additionally, or alternatively, be stored on, and executed by, the computing devices 110 and/or other devices. For example, in certain embodiments, the computer vision system 150 can be integrated directly into a camera device to enable the camera device to analyze images using the techniques described herein.

Likewise, the computer vision system 150 can also be stored as a local application on a computing device 110, or integrated with a local application stored on a computing device 110, to implement the techniques described herein. For example, in certain embodiments, the computer vision system 150 can be integrated with (or can communicate with) various applications including, but not limited to, facial recognition applications, automated vehicle applications, intelligent traffic applications, surveillance applications, security applications, industrial quality control applications, medical applications, agricultural applications, veterinarian applications, image editing applications, social media applications, and/or other applications that are stored on a computing device 110 and/or server 120.

In some particularly useful applications, the neural network architecture 140 can be integrated with a facial recognition application and generates pseudo-images to aid in identification of faces or facial objects. For example, upon receiving a given image 130 that includes a facial object, the neural network architecture 140 robustly can generate a consistent pseudo-image of unknown or altered form (e.g., which may include an altered facial object) and the pseudo-image may be used for facial recognition purposes. Storage of the actual facial objects is not required, which can be beneficial both from a technical standpoint (e.g., by decreasing usage of storage space) and a privacy standpoint.

In certain embodiments, where continuous learning by the neural network architecture 140 is not utilized, the neural network architecture 140 can be deployed with a pre-learned weight matrix so that it is immediately available for its assigned application. In addition, the neural network architecture 140 can also perform additional learning, if preferred, even if it was deployed with a pre-learned weight matrix. In certain embodiments, where no or few new objects are expected, the neural network architecture 140 with a learned set of weights can be stored and used directly without any learning (or adaption) mechanism to accelerate its performance. Alternatively, or in addition, the neural network architecture 140 can be allowed to continuously update its weights to account for novel objects.

In certain embodiments, the one or more computing devices 110 can enable individuals to access the computer vision system 150 over the network 190 (e.g., over the Internet via a web browser application). For example, after a camera device (e.g., which may be directly integrated into a computing device 110 or may be a device that is separate from a computing device 110) has captured one or more images 130, an individual can utilize a computing device 110 to transmit the one or more images 130 over the network 190 to the computer vision system 150. The computer vision system 150 can analyze the one or more images 130 using the techniques described in this disclosure. The analysis information 160 generated by the computer vision system 150 can be transmitted over the network 190 to the computing device 110 that transmitted the one or more images 130 and/or to other computing devices 110.

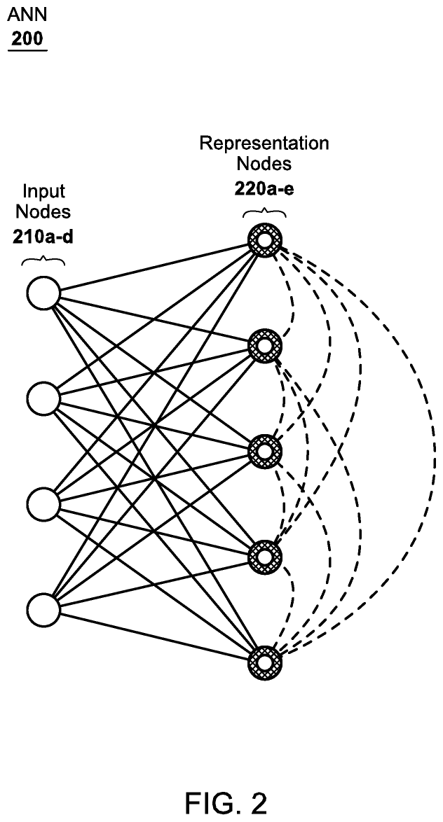

As illustrated in FIG. 2, the neural network architecture 140 can include a shallow, bi-layer ANN 200 (e.g., a modified Hopfield network) that comprises a first layer of input nodes 210a-d (which may also be referred to herein as primary layer nodes) and a second layer of representation nodes 220a-e (which may also be referred to herein as discrimination nodes, representation nodes or secondary layer nodes). Each of the input nodes 210a-d can be connected to each of the representation nodes 220a-e in an all-to-all configuration. In certain embodiments, the initial feedforward weights between the input 210a-d and representation nodes 220a-e can be chosen in part on the variance structure of the input dataset to minimize the chances that any two representation nodes 220a-e are active at the same time. Additionally, the representation nodes 220a-e can be connected to each other in an all-to-all configuration using recurrent connections that are inhibitory. The biased connectivity and lateral inhibition in the neural network architecture 140 enable the nodes to encode structures that uniquely identify individual objects 135. The sparsity of the object representations 165 of the objects 135 embedded in the images 130 is due to the inhibitory recurrent connections between the representation nodes 220a-e. These inhibitory connections are not present in a traditional Hopfield network, which contains excitatory recurrent connections.

In some embodiments, the bi-layer ANN 200 can be configured to be adaptive, such that the connectivity between the input layer nodes 210a-d and the representation layer nodes 220a-e is permitted to change based on a given input image that is being processed. This dynamic adaptation of the connections between the input layer nodes 210a-d and the representation layer nodes 220a-e enables the bi-layer ANN 200 to optimize the object representations 165 that are generated. The resulting object representations 165 are sparse, and individual representation layer nodes 220a-e of the bi-layer ANN 200 are de-correlated, thereby leading to efficient coding of the input patterns. Moreover, because the bi-layer ANN 200 can extract the informative structures from the objects 135 in the images 130, the resulting object representations 165 are robust against various forms of degradation, corruption and occlusion.

In certain embodiments, the weights between any two nodes are updated using local learning rules. For example, the connection between an input node and a representation node can be strengthened when both nodes are active. When two of the representation nodes 220a-e are active at the same time, the input connections to these two nodes are weakened and the inhibitory weights can be increased when two of the representation nodes 220a-e have the same level of activity. The strengthening of connections between input nodes 210a-d and representation nodes 220a-e is an example of local Hebbian behavior while the weakening of any two of the representation nodes 220a-e that are active at the same time is an example of local anti-Hebbian behavior.

The manner in which these connections are strengthened or weakened can be uniquely modeled using local learning rules in the representation nodes 220a-e to mimic real-world biological cognitive processes. In biological systems, Hebbian learning rules (where to store p patterns in a network with N units, the weights that ensure recollection of the patterns are set using

$${w}_{ij} = \frac{1}{N} {\sum }_{r = 1}^{p} {x}_{i}^{r} {x}_{j}^{r}$$

where x^{r}ᵢ denotes the state of the i^{th} unit in the r^{th} pattern) generally specify that when the neurons are activated and connected with other neurons, these connections start off weak, but the connections grow stronger and stronger each time the stimulus is repeated. Similarly, in the ANNs 200 described herein, connections between the input nodes 210a-d and representation nodes 220a-e are strengthened when connections are formed, thereby establishing associations between features extracted by the input nodes 210a-d and representation nodes 220a-e that can capture the related feature information. Additionally, when two of the representation nodes 220a-e are co-active, the learning rules can reduce the strengths of the connections between the input nodes 210a-d and those tow of the representation nodes 220a-e. Further, at initialization, the connectivity between the input nodes 210a-d and the representation nodes 220a-e takes the variance structure of the input dataset into account and ensures that any two of the representation nodes 220a-e are less likely to fire together for any given input. This approach to the initial bias of the ANN 200 can enhance learning speed.

In certain embodiments, the bi-layer ANN 200 is able to quickly represent images 130 after it has been exposed to them. For example, the bi-layer ANN 200 can accurately capture the structural features of input including images of symbols from world languages, reaching a plateau of performance, after less than ten exposures to the symbols. Further, the bi-layer ANN 200 is capable of continuous learning. For example, the bi-layer ANN 200 can learn to represent novel input types (such as faces) after learning to represent a different input type (such as symbols from world languages) without “forgetting” how to represent the earlier input type.

In certain embodiments, the number of representation nodes 220a-e included in the neural network architecture 140 may be proportional to the number of images 130 or objects 135 for which recognition is desired. In such instances, the representation layer 220 may contain approximately the same number of nodes as the number of images 130 to be identified. In some embodiments, there may be 2x, 10x, or more expansion of the number of nodes from the input layer 210 to the representation layer 220. For many applications of the neural network architecture 140, more nodes in each layer yield better results. There is no upper bound on the number of total nodes comprising the neural network architecture 140. In certain embodiments, there may be fewer nodes in the representation 220 or classification (discussed in more detail below) layers than in the input layer 210. For example, the input layer of the bi-layer ANN 200 can have 10,000 nodes and 500 nodes in the representation layer. In another example of the bi-layer ANN 200, the input layer 210 can include 10,000 nodes and the representation layer 220 can include 1,000 nodes.

In certain embodiments, slow synaptic weight changes allow continuous learning from individual examples. In such embodiments, the slowness (relative to traditional image analysis systems) does not cause disturbances in the overall network connections, but allows specific patterns to be encoded. In some embodiments, there is no normalization step with each learning iteration, which can prevent the production or assignment of negative synaptic weights. Such a result is due to the slow synaptic weight changes and is similar to biological systems (e.g. in animal brains, where synaptic weights never go negative).

The characteristics of the representation nodes 220a-e in the second layer can be modeled or based upon the characteristics of neurons observed in biological systems. For example, certain concepts such as membrane potential and firing rate, taken from biological neural networks, or neurons therein, can be used to set the attributes of the nodes in the ANN 200. The connections between the (primary) input layer nodes 210a-d and the (second) representation layer nodes 220a-e can be represented by a connection matrix, with the shape of the connection matrix depending on the number of input nodes 210a-d and number of representation layer nodes 220a-e (and, as such, need not be symmetric). The recurrent connections between the representation nodes 220a-e in the second layer, on the other hand, can be described by a symmetric matrix. In certain embodiments, the connection strength from node i to node j in the representation layer 220 is the same as the connection strength from node j to node i.

The connection strengths between the nodes can either be static or adapt over time. For example, the properties of the nodes can change as the ANN 200 encounters inputs. In certain embodiments where the ANN 200 is not adapted especially to certain types of input, the properties of the representation nodes 220a-e in the second layer arise due to their connections to the input nodes 210a-d. Therefore, the strength of recurrent connections can be the similarity of representation nodes' 220a-e connections to the primary nodes 210a-d. In embodiments where two of the representation nodes 220a-e are similarly connected to the input nodes 210a-d in the primary layer, any given input would similarly activate them and their recurrent interactions would be similar as well.

The ANN 200 can be completely dynamic in some embodiments. For example, it can adapt to the inputs not only through the changes in connections between the input nodes 210a-d and the representation nodes 220a-e but also through updating recurrent connections' strengths (between the representation nodes 220a-e). In certain embodiments, the dynamics of the ANN 200 can be modeled as

$$τ \frac{d \hat{u}}{dt} = - \hat{u} + {W}^{T} \hat{y} - ( {W}^{T} W - I ) \hat{V ;} where$$

$$\hat{u} = {g}^{- 1} ( \hat{V} ) .$$

W is the matrix of weights between the input nodes 210a-d in primary layer connected to the representation nodes 220a-e of the second layer, τ (tau) is a time constant related to the parameters of the neuron model, ŷ is the activity of the first layer, û is the vector of membrane potentials and \hat{V} is the firing rate or the representation pattern of the nodes in the second layer. The function g can relate the membrane potential to the firing rate of neurons in a biological system. In certain embodiments, the membrane potential can be the same as those found in existing models. The recurrent connections of the second layer S are related to the weights between the input nodes 210a-d and representation nodes 220a-e by the following equation: S=−(W^{T}W−I).

The nodes in the ANN 200 can exhibit certain non-linear behavior. For example, the nodes 220a-e in the representation layer can have a certain threshold, with the node inactive (or not ‘firing’) when its value is below the threshold. This value can be determined by summing the inputs to the node as multiplied by the weights applied to those inputs. After the threshold is reached, the node can respond linearly to its inputs. In certain embodiments, this region of linear response may be limited, for instance, because the node response will saturate at a certain level of activity. The behavior of the nodes can be modeled in a number of ways. In certain embodiments, the behavior of the representation nodes 220a-e of the ANN 200 are modeled on biological structures, such as neurons. The behavior of these nodes is determined by certain parameters taken from the biological context: membrane potential, firing rate, etc. For instance, the nodes in the representation layer 220a-e can be modeled using the “Leaky Integrate and Fire” model.

In certain embodiments, the fitness or quality of adaptations of the ANN 200 can be measured by the difference between an input and its reconstruction obtained from the representation nodes' 220a-e tuning properties and response values. This fitness of adaption can be modeled as: E=∥ŷ−ϕ\hat{V}∥², where ϕ is the matrix of the tuning properties of the nodes, and where E is reduced with each update. This term can be used to measure the discrepancy between the input into the input layer 210 and the representation derived from the representation layer 220. In certain embodiments, this term, when combined with the sparsity and non-negative constraints, can help derive the learning rules for the ANN 200 (as described in more detail below). In embodiments where the nodes behave linearly, the activity of each node is a function of the weighted sum of its inputs, so that a change in tuning properties directly corresponds to a change in its connectivity i.e. ΔW α Δϕ.

The connectivity of the ANN 200 can be updated in a number of ways. For example, it can be updated using the following three step procedure. First, for each state of connectivity, the tuning properties are determined. Second, a change in tuning properties that would reduce the error is then calculated from the representations, and lastly, a change proportional to that is made in the connectivity.

The inability of the ANN 200 to differentiate between different inputs can undercut its effectiveness. In certain embodiments the ANN 200 can be optimized to represent inputs based on the most informative structures and to adapt to different forms of inputs, the initial weights of the ANN 200 can be set to achieve differentiating between different inputs from the first inputs that it inputted. Otherwise, the ANN 200 may not be able to distinguish between two different inputs, leading to a flawed adaptation process resulting in only selective adaptation.

In certain embodiments, the initial weights are set so as to minimize the chances of having any two of the representation nodes 220a-e activated by the same input to ensure that different inputs activate different nodes, avoiding mapping different inputs to the same representation. This constraint can be modeled by setting the expected value of the variance-covariance matrix of the response profiles of nodes to be an identity matrix i.e. E[VV^{T}]=1 where V is the matrix of representations of different inputs and I is an identity matrix. In embodiments where the non-linearity conferred to the ANN 200 by the function g is ignored, V can be approximated in terms of input matrix and weight matrix W as V=W^{T}Y, where Y is the input matrix. The weight matrix W can be calculated based on the variance-covariance matrix of response profiles of early nodes (denoted by Σ_{yy}) based on the set of inputs as

$${W}^{T} = η {Λ}^{\frac{- 1}{2}} {Q}^{T}$$

where η is an N×M generalizing matrix of real numbers with orthogonal columns, Λ is the diagonal matrix of eigenvalues of Σ_{yy}, and Q is the matrix of orthogonal eigenvectors of Σ_{yy}. M is the number of primary nodes and N is the number of representation nodes. In certain embodiments, η is created by first constructing an N×N symmetric matrix (when N is greater than M) and calculating its eigenvectors. The generalizing matrix can then be created by taking M of the eigenvectors. In other words, a connectivity matrix W as derived above will make the variance-covariance matrix of representation nodes' response profiles match the identity matrix.

Complete knowledge of inputs is not required. For example, a subsample of the inputs that are more likely to be encountered can also set up the ANN 200 such that the expected inputs of the ANN 200 are not mapped to the same representation. In certain embodiments where N is greater than or equal to M, the ANN 200 can be generalized by ensuring that η has orthogonal columns (in other words, when the number of representation nodes is larger than the number of primary nodes).

In certain embodiments where the connectivity between the primary layer input nodes 210a-d and the representation layer representation nodes 210a-e of the ANN 200 is updated, the updating can be stated as an optimization problem with the goal of minimizing ϕ, with

$$f ( ϕ ) = \frac{1}{2} {‖ \hat{y} - ϕ \hat{V} ‖}^{2}$$

where ŷ is the input to the ANN 200 and \hat{V} is its corresponding output.

This optimization problem for updating the connectivity between the primary layer input nodes 210a-d and the representation layer representation nodes 220a-e can be solved by taking a gradient descent approach. In this approach, a function's value is iteratively reduced by updating its variables along its gradient. In other words, for every variable, the value which further reduces the function is found by moving along the functions' negative gradient with respect to the variable. Eventually, a minimum of the function is reached. The gradient descent steps can be formulated as

$$Δ {ϕ}_{n} = \frac{{\tilde{α} ( 1 - \tilde{α} )}^{n - 1}}{‖ {\hat{V ‖}}^{2}} ( \hat{y} - {ϕ}_{0} \hat{V} ) {\hat{V}}^{T}$$

where α is the step size and α=\tilde{α} ∥\hat{V}∥².

In embodiments where \tilde{α} approaches zero, Δϕₙ approaches 0 for any value of n, meaning that there is no gradient descent. In embodiments where \tilde{α} is greater than 1, then Δϕₙ starts oscillating with n. In embodiments where \tilde{α} is equal to 1, Δϕₙ equals 0 and ϕₙ=ϕ₀M(Λ^{p}=Λ∀ p) where M=QΛQ^{T} where

$$Λ = D ( \begin{matrix}1 - \tilde{α} \\ ⋮ \\ 1\end{matrix} )$$

where D represents a diagonal matrix, with diagonal elements given by the column vector as the argument. Furthermore, M^{p}=QΛ^{p}Q^{T} where

$${Λ}^{p} = D ( \begin{matrix}{( 1 - ã )}^{p} \\ ⋮ \\ 1\end{matrix} ) .$$

In these embodiments, there is also no descent.

In embodiments where \tilde{α} ∈ (0,1), (1−\tilde{α} )^{p} falls faster than (1−\tilde{α} ) for any p>1, when it is assumed that (1−\tilde{α} )=∈ will imply (1−\tilde{α} )^{p} ∈−ω²ₚ is a finite positive number whose value depends on p. In embodiments where ∥\hat{V}∥² is constrained to equal 1, ϕₙ=ϕ₀+C(ŷ\hat{V}^{T}−ϕ₀\hat{V}\hat{V}^{T}) where C is a constant which equals (1−(1−α)ⁿ). Thus, after n steps of gradient descent, the change in ϕ has two components, an additive component given by the rank one matrix ŷ\hat{V}^{T}, and a subtractive component given by the rank one matrix ϕ₀\hat{V}\hat{V}^{T}. The matrix ŷ\hat{V}^{T} will have positive entries at the location (i,j) if and only if yᵢ and Vⱼ are both positive. Thus, this matrix corresponds to the Hebbian update rule that strengthens the connection when one of the input nodes 210a-d in the primary layer and one of the representation nodes 220a-e in the representation layer fire together. Similarly, matrix \hat{V}\hat{V}^{T} can be positive only when Vᵢ and Vⱼ are both positive.

However, the negative sign before this update component makes it anti-Hebbian in nature, i.e., the update reduces all the connections between input nodes 210a-d in the primary layer and two similarly active nodes in the representation layer 220. In other words, if two of the representation nodes 220a-e are firing together, their input is reduced so that they can be decoupled. Overall, an update in connectivity strengthens the connections between simultaneously firing nodes in the primary layer 210 and the representation layer 220 but reduces the chances of two of the representation nodes 220a-e firing together. This process allows that the ANN 200 can gradually get tuned to features from the multiple inputs presented to it.

In certain embodiments where updating the connections to adapt to a novel input in the way described above disrupts the ANN's 200 adaptation to the previously encountered inputs, the ANN 200 can utilize simultaneous re-learning of features from all the previous inputs to minimize the effects of such disruptions.

In certain embodiments, the ANN 200 can use a stochastic gradient descent (SGD) to solve the problem of disruption of the ANN's adaption to previously encountered inputs. This is a stochastic approximation of gradient descent optimization. In this method, instead of optimizing the objective function for all the training data, The ANN 200 optimizes the function for only a randomly selected subset of the data. To better understand this approach, it is possible to approach any optimization problem as a finite-sum problem, where the value of the objective function can be expressed as a sum of losses for each data point, i.e., f (x)=Σᵢ₌₁^{N} fᵢ (x). Here f is the objective function, fᵢ is the loss at the i^{th} data point and x is the optimization variable. The gradient of the objective function, then, is the gradient of this finite-sum, which is calculated with respect to every training data point:

$$\frac{df ( x )}{dx} = {\sum }_{i = 1}^{N} \frac{{df}_{i} ( x )}{dx} .$$

Using SGD, each step of descent is decided using only a subset of training data points, and hence, the gradient is decided based only on a portion of this finite sum:

$$\frac{df ( x )}{dx} = {\sum }_{j ∈ S} \frac{{df}_{j} ( x )}{dx}$$

where S ⊂ [1, N]. Though this strategy does not reach optimum, it can reach very close to the objective function's optimum value.

In certain embodiments, the ANN 200 is designed to update its connectivity so that it learns to efficiently represent a finite set of inputs based on their most informative structures. The objective function can be used as the measure of adaptiveness, the optimization variable can be used as the matrix of tuning properties, and the training data points can be used as the pairs of inputs and their corresponding representations. As a single input can be a subset of data points, the SGD method can train the ANN 200 for all the inputs presented in a sequence although the SGD does not reach the optimum. The step size can be any size when using the SGD method. In certain embodiments, the step size for a given implementation of the ANN 200 can be determined through an iterative process. The process begins by selecting a very small step size and running simulations of the ANN 200 against certain test input data. As the weights of the ANN 200 adjust, the output of the ANN 200 can be compared to an optimum output for the inputted test data. The value of the step size can be adjusted upwards until the output of the ANN 200 is mismatched with the input. However, since only a subset of data points is considered while estimating the gradient, taking larger gradient steps in SGD may throw the updated point very far from the optimum. In certain embodiments, only small step sizes are used. The adaptation process can also require that the connectivities be updated to a particular strength to make the adaptation effective (a smaller update in connectivity may not be differentiated from unadapted connectivity), so that a minimum step size or a minimal update is necessary. To address this issue, updates to the connectivity are performed with smaller step sizes and utilize multiple presentations of the same input to reach the desired adaptation level. These kinds of updates can be realistically implemented and provide a way to understand how the frequency of inputs affected the adaptation process.

Unlike certain traditional approaches, such as matrix factorization that are unable to represent inputs not included in the input matrix (and which may require separate algorithms to be used for the sparse recovery of inputs), the ANN 200 can perform both of these tasks (that is solving sparse recovery problems and updating the connectivity between primary layer input nodes 210a-d and representation nodes 220a-e using SGD). The ANN 200 can function in two modes. In Mode 0 the ANN 200 can only perform a sparse recovery, because the connectivity between the primary 201a-d and representation 220a-e nodes and the input are given as arguments to the ANN 200, to produce the desired representation. When functioning in Mode 0, no update in connectivity is performed. In Mode 1, the ANN 200 performs both sparse recovery and basis adaptation with initial connectivity and input given as arguments to the ANN 200. In mode 1, the ANN 200 can also produce a sparse representation of the input and the connections between various nodes are updated using the obtained representation and the corresponding input to ensure learning. The ANN 200 operating in Mode 1 can learn to represent the initial sets of data (such as training set data) really well, but the ANN 200 can also perform well for images 130 similar to those included in an initial (or training) data set but not identical. The ANN 200 can adapt to the new images 130 and represent them more sparsely and more robustly because it can employ continuous learning.

The ANN 200 described herein differs from traditional hierarchical assembly models, which attempt to explain the increasing complexity of receptive field properties along the visual pathway and later formed the foundation of convolutional neural networks. These traditional models assume that neurons in the cognitive centers recapitulate precise object details. However, accurate object image reconstruction is not always necessary for robust representation, and this deeply rooted assumption creates unwanted complexity in modeling object recognition.

The ANN 200 described herein does not have to calculate reconstruction errors to assess its learning performance. By capturing dependencies that define objects 135 and their classes, it can produce remarkably consistent representations of the same object 135 across different conditions. The size, translation, and rotation invariance show that the ANN 200 can naturally link features that define an object 135 or its class together without ostensibly being designed to do so. It permits the non-linear transformation of the input signals into a representation geometry suitable for identification and discrimination. One aspect of the ANN 200 is that it can generate invariant responses to corrupted inputs in part because its design takes inspiration biological systems. Sensory stimuli evoke high-dimensional neuronal activities that reflect not only the identities of different objects but also context, the brain's internal state, and other sensorimotor activities. The high-dimensional responses can be mapped to object-specific low-dimensional manifolds that remain unperturbed by neuronal and environmental variability.

One distinguishing feature of the ANN 200 in comparison to traditional frameworks is that the initial connectivity between the input nodes 210a-d and the representation nodes 220a-e in the discrimination (or representation) layers takes the variance structure of the input dataset into account and ensures that any two of the representation nodes 220a-e are less likely to fire together for any input. Moreover, the learning process does not utilize any label, nor require any pre-determined outcomes. It is entirely unsupervised, as the representations evolve with exposures to individual images. Thus, the recurrent weights do not reflect the correlation structure between pre-determined representation patterns. Notably, the learning rules are all local and modeled as the following: Δϕ=α(ŷ\hat{x}^{T}−ϕ\hat{x}\hat{x}^{T}); w=(ϕ−Δϕ); (ϕ−Δϕ) where ŷ is an input vector, \hat{x} is its representation in the discrimination (or representation) layer, ϕ is the connectivity between the input nodes 210a-d and the representation nodes 220a-e in the discrimination (or representation) layer, α is the learning rate, and w is the recurrent inhibition weight matrix. The updates enable the ANN 200 to learn comprehensive input structures without resorting to using reconstruction error or credit assignment. In certain embodiments, the learning rules are implemented through a combination of matrix operations and differential equations to compute and adjust the weights of the ANN 200.

Concurrent with the linear sum of activities to drive responses, the ANN 200 adjusts connection strengths in an activity-dependent manner. The first term (ŷ\hat{x}^{T}) of the learning rule is a small increment of the connection strengthens when both one or more input nodes 210a-d and one of the representation layer representation nodes 220a-e are active. This update allows the association between a feature (in the input) with the representation unit to capture the information. The second term (ϕ\hat{x}\hat{x}^{T}) indicates that when two of the representation nodes 220a-e in the recurrent layer are co-active (and mutually inhibited), the strengths of all connections from the nodes in the input layer 210a-d to these nodes are reduced. The inhibitory weights in the recurrent (second or representation) layer 220 are such that any two of the representation nodes 220a-e responding to similar inputs have strong mutual inhibition. These updates are essentially local Hebbian or anti-Hebbian rules, where connection updates are solely determined by the activity of the nodes. This configuration, i.e., the initial biased connectivity and local learning rules, distinguish the ANN 200 from existing neural networks, which incorporate random initial connections from the input layer that do not update (e.g., the convolutional input strengths in other models). Moreover all activities in the nodes and the connections are non-negative, reflecting constraints from biological neural networks.

The ANN 200 can denoise inputs and extract cleaner structures from them. The receptive fields of the representation nodes 220a-e of the ANN 200 can produce structures that resembled faces (along with random noise) inputted into the ANN 200 but were not specific to any input face. The receptive fields can be much less noisy than the inputted faces at all levels of training, as measured by average power in the highest spatial frequencies. (A higher mean power indicated higher noise content.)

The ANN 200 can have the ability to learn from pure experience and generate consistent representations. It can achieve prospective robustness, defined as consistently representing input patterns it has never experienced. For instance, the ANN 200 has the ability to represent facial images not in the training set, including unseen pictures corrupted by Gaussian noises or with occlusions. The ANN 200 can generate sparse and consistent representations of the new faces. Representation of corrupted inputs can be nearly identical to that of the clean images with even images with large occlusion represented consistently. The specificity of the ANN 200 can be high for corruptions with all noise levels and occlusions.

The ANN 200 trained on a specific set of images rapidly learns the receptive fields (in the representation, or second layer 220) that conform to the images. For example, in an ANN 200 trained using symbols from world languages, similarity between the receptive fields and the symbols increases rapidly as the ANN 200 repeatedly encounters the same characters. The specificity of symbols' representations increases even faster, reaching a plateau with less than 10 exposures. Thus, the ANN 200 effectively captures structural features that are maximally informative about the input.

The ANN 200 can learn to represent novel input types without compromising its previous discrimination abilities. For example, the ANN 200 can be trained to represent a fixed set of symbols, followed by learning faces. Although learning faces after the characters can change the receptive field properties of a subset of nodes; however, for the ANN 200, the specificity of symbol representations before and after learning a different input, such as faces, remained comparably high. The ANN 200 can also maintain high specificity of face representations (or vice versa). In other words, the ANN 200 avoids the catastrophic forgetting problem encountered by the many other neural network models. The ANN 200 can learn from images 130 of symbols that were corrupted, such as with different fractions of pixels flipped.

The ANN 200 can have any number of nodes in its primary layer 210 and in its representation layer 220. For example, the ANN 200 can have 256 primary nodes and 500 representation nodes.

In certain embodiments, the ANN 200 is constructed so that it can successfully differentiate inputs before adaptation. The ANN 200 can be constructed in a number of ways to differentiate inputs before adaption. For example, the ANN 200 can use non-negative uniform connectivity where the connection strengths between the primary layer input nodes 210a-d and representation nodes 220a-e of the secondary layer were chosen to be values between 0 and 1. With non-negative uniform connectivity, the probability of a connection strength attaining any value was the same, i.e., the connection weights are derived from a uniform distribution over (0, 1). The weights can be normalized such that the length of the weight vector corresponding to any representation node is 1.

The ANN 200 can also be constructed using normally distributed connectivity where the weights are derived from a normal distribution with mean 0 and standard deviation 1. The weights can also be normalized to have length 1.

The ANN 20 can also be constructed with decorrelating connectivity where the weights are normalized in this case too to have length 1. The decorrelation can be based on the eigenvectors of the variance-covariance matrix of the inputs. In certain embodiments only 150 eigenvectors were utilized as affective dimensions of the input space since the variance of the input space along these vectors becomes saturated after 150 dimensions; however other numbers of eignenvectors can be used to create the variance-covariance matrix of the inputs.

The Frobenius norm of the correlation and identity matrices' difference can be calculated and used to measure the difference between the two matrices. Lower Frobenius norms indicate better decorrelation. In certain embodiments, the Frobenius norm of the difference between the correlation matrix and the identity matrix was lowest for the decorrelating model of connectivity, indicating that it could decorrelate the nodes most. When the input to the ANN 200 comprises 500 images 130, each image 130 can correspond to each of the 500 representation nodes, and each of the pixels in each image correspond to each of the primary nodes.

The ANN 200 can adapt to any number of input sets of images. For example, the ANN 200 can adapt to input sets containing 500, 800, or 1000 inputs. Each input can be presented repeatedly (for example, up to 100 times) to allow for adaptation (for instance using SGD) with the inputs presented one at a time in a sequence (with the order of their presentation randomly chosen). Changes can be calculated with respect to the initial decorrelating connectivity and represent how strongly a particular node of the representation nodes 220a-e is connected to primary layer nodes 210a-d. As an input node (that is one of the input nodes 210a-d) strongly connected to a representational node (of the representation nodes 220a-e) will elicit a maximum response in that representation node, these connections can reflect the representation nodes' 220a-e tuning properties. In certain embodiments, different representation nodes 220a-e get tuned to different structures from the inputs. A distribution of cosine similarity of the connectivity changes for different nodes across different states can be used to determine if connectivity similarity was maintained while repeatedly encountering symbols. A sustained similarity level indicates that the distinctiveness of node tunings remained unaltered. These similarity levels can measures the overall connectivity changes in a particular state but they do not provide information about how connectivity changed for individual nodes across different states.

In certain embodiments, the connectivity structure of the ANN 200 does not change for individual nodes, the similarity of connectivity to nodes increases slightly over states and then saturates, which illustrates that the connections to individual representation nodes 220a-e were slightly changing as inputs were encountered repeatedly and then reached a stable state after a certain number of encounters. This can demonstrate how attainment of such a stable state in nodes' connectivity eventually reaches saturation. This suggests that in certain embodiments of the ANN 200, only the first few encounters of any input change the structure of connectivity and the representations of the inputs change based on the immediate experience of the ANN 200 and saturate afterward. This saturation highlights the critical difference between the framework of the ANN 200 and the classical efficient coding paradigm, where the representations of inputs depend upon their overall statistical and not just immediate encounters.

For certain embodiments, a low average similarity (<0.5) is observed, indicating that the connections of different nodes changed differently. The average similarity remains consistently small and slightly decreased with the state.

As the ANN 200 encounters an input an increasing number of times, the structures outputted by the ANN 200 become more input-like. In certain embodiments, the ANN 200 successfully identifies comprehensive, unique structures from the inputs by encountering the same inputs repeatedly; however, with increasing the number of distinct inputs, the representation nodes 220a-e tune to more localized structures.

Cosine similarity between changes in connectivity and input to the ANN 200 can be measured at different stages. In certain embodiments, the similarity increased with the network state but decreased with the increasing number of inputs.

In certain embodiments, the representations of the ANN 200 become sparser with more encounters of the inputs. Moreover, with an increasing number of inputs, the responses of the ANN 200 are confined to a smaller number of nodes. Representation efficiency can be quantified in three ways to highlight the changes that occur while adapting to a varying number of inputs (response profiles' correlation, kurtosis, and sparsity). These measures can be measured across different states of the ANN 200, as well as across the different numbers of inputs. In certain embodiments, when the ANN 200 experiences more inputs, the representation nodes' 220a-e response becomes increasingly non-Gaussian. Increasing the number of input presentations can also increase the kurtosis of node response profiles. Both experience and sampling of inputs can increase the representation efficiency of the ANN 200. The correlation among the representation nodes 220a-e can also decrease (as indicated by the smaller Frobenius norm of the difference of correlation and identity matrices and by the L0 and L1 sparsity measures) with more encounters of the same set of inputs, as well as encounters of new inputs. The responses of the ANN 200 can become sparser with the adaptation states as well as with the number of inputs. Nodal response profiles' kurtosis calculations can assess the efficiency in terms of representation sparseness. Nodal response profile's Kurtosis increased with the ANN 200 network states as well as the number of inputs. The correlation among nodes can be measured, and the Frobenius norm of the difference between correlation and identity matrices can be calculated. The norm too can decrease with the states and the number of inputs, indicating a decorrelation trend. The sparsity of representations can also show similar trends for ANNs 200 in accordance with certain embodiments. Both the L0 and L1 sparsity measures can decrease with the ANN 200 network state while maintaining the levels across the number of inputs. The performance of the ANN 200 in accordance with certain embodiments outperform those obtained through known approaches such as the matrix factorization, where the efficiency in representation drops with increasing inputs.

The ANN 200 can produce consistent representations at different network states across all types of corruption. For example, when experiencing five different inputs in their corrupted forms, the representations are consistent across different forms of corruption and across different states of the ANN 200. The specificity of representations for different forms of corruption can be calculated using the z-scored cosine similarity between the representations of uncorrupted and corrupted inputs. Specificity can increase slightly with practice, i.e., after encountering the inputs a greater number of times for all forms of corruption (with high specificity of representations being observed with a slight increase in the network's 100^{th} state). The representations of the ANN 200 in the 100^{th} state can be sparser than the representations in the 50^{th} state. The specificity can decrease with increasing levels of corruption, occlusion, or addition of noise. In certain embodiments the representations' consistency increased with the representation nodes 220a-e of the ANN 200 becoming more specific by getting tuned to unique features from the inputs. The ANN 200 does not need to know the entire input space's statistics to be efficient and can produce consistent representations of inputs under varying circumstances.

The ANN 200 can similarly generalize an input when seeing various variations of it. When experiencing corrupted inputs (such as inputs with 10%-20% of their pixels altered), the change in connectivity in the ANN 200 can resemble uncorrupted inputs much as in the case of adaptation to non-corrupted symbols. Although similarities can vary from input to input, the maximum similarity observed with any input to the ANN 200 is high. The ANN 200 is able to find the consistency that existed across the input variants and adapt to it, similar to complex deep or convoluted neural networks that have been shown to perform in this manner. However unlike embodiments of the ANN 200 (including those of only two layers and learning from 800 examples), these other networks are very complex, contain multiple layers, and require numerous examples.

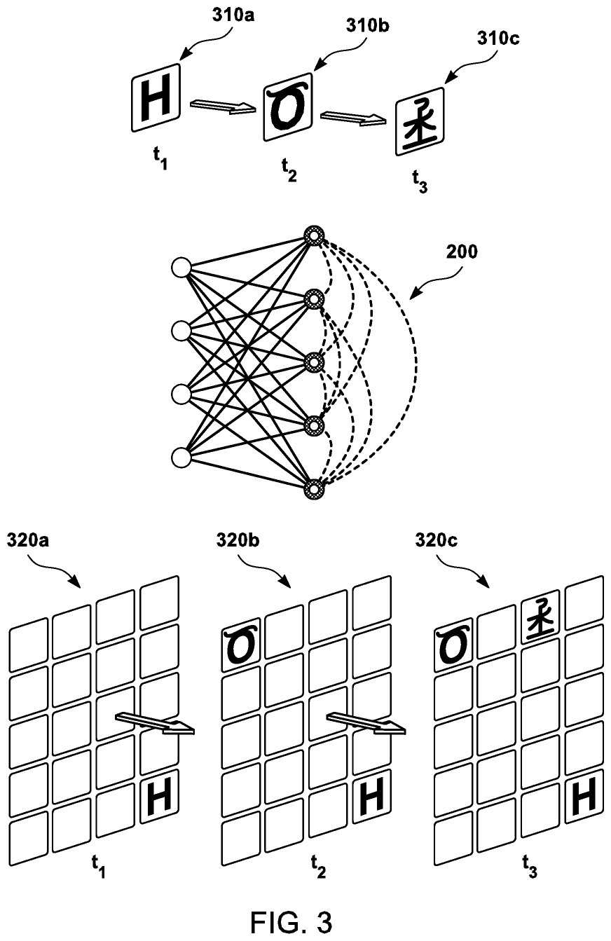

FIG. 3 is a diagram illustrating how inputs in an input sequence are tuned in the representation layer for an ANN 200 in accordance with certain embodiments. A series of symbol images 310a-c can be input sequentially in time into the input layer input nodes 210a-d of the ANN 200. The ANN 200 learns each symbol in the series of symbol images 310a-c and can reconstruct the symbol from the output of the representation nodes 220a-e. Between the inputting of each symbol 310a-310c into the ANN 200, the weights between the input nodes 210a-d and the representation nodes 220a-e or the weights between representation nodes 220a-e or both can be updated. The ANN 200 does not experience catastrophic forgetting. As such, as each symbol in the series 310a-c is inputted, the ANN 200 captures its characteristics and remembers them, as represented on the sequence of grids 320a-c. The fact that each symbol takes up its own square of the grids 320a-c illustrates that the ANN 200 does not forget and is able to learn sequentially. Symbol grid 330 represents a subset of learned tuning properties of the representations. The symbol grid 330 demonstrates that the most informative components of the inputted symbols 310 are captured by the ANN 200.

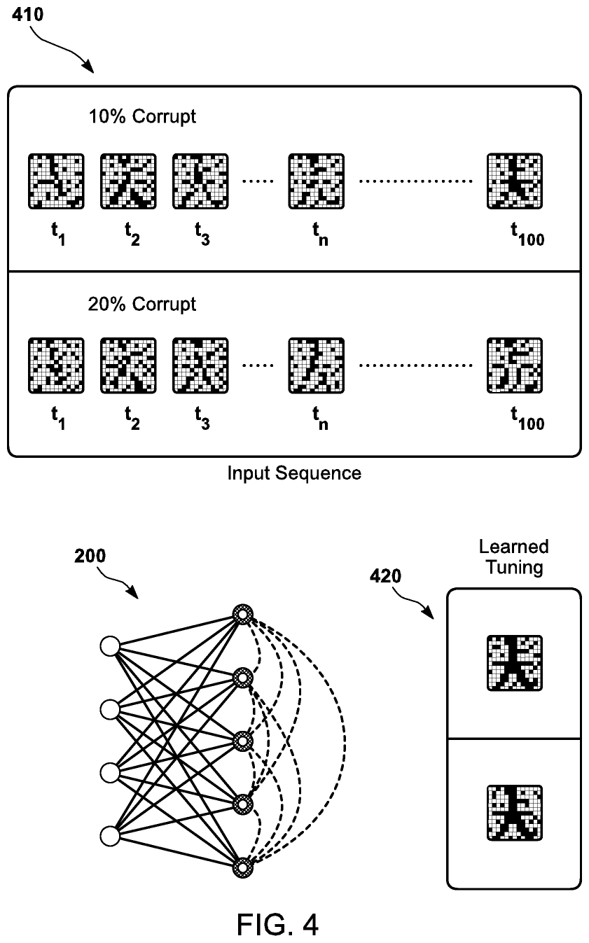

FIG. 4 is a diagram illustrating how corrupted inputs included an input sequence can be learned by the representation layer 220 for an ANN 200 in accordance with certain embodiments. The series of corrupted symbol forms 410, which, for instance, may be generated by randomly flipping a certain percentage of pixels (such as 10% or 20% of the pixels) is inputted into the input nodes 210a-d of the ANN 200. The series of corrupted symbol forms 410 can include around 100 different corruptions of each symbol. The tuning properties 420 learned by the ANN 200 are clean versions of the inputted symbol forms 410.

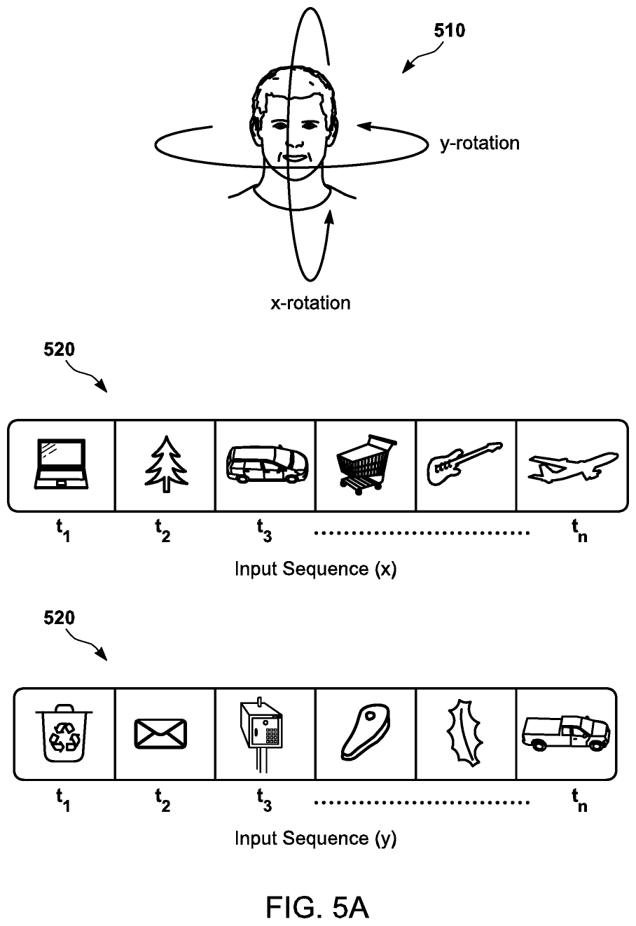

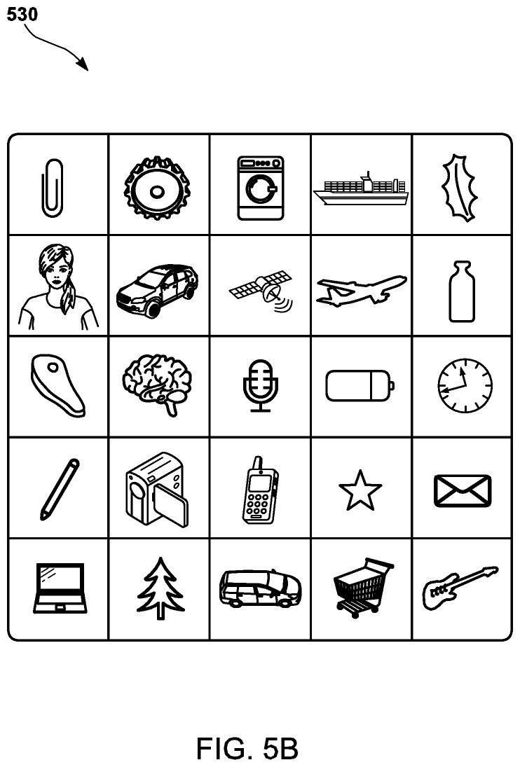

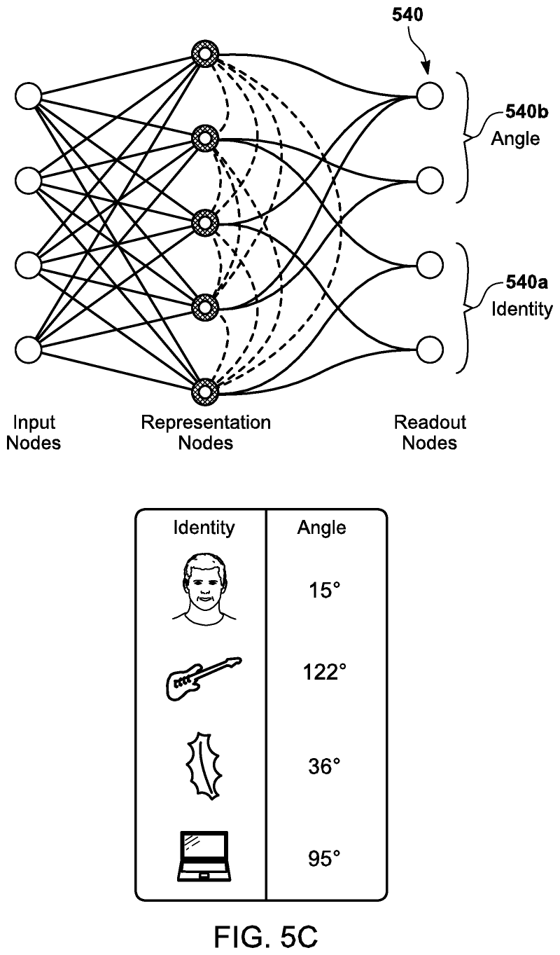

FIG. 5 is a diagram illustrating how characteristics of an object, varying views of which are inputted, are captured in the output of an ANN 200 in accordance with certain embodiments. 3D models of different objects were rotated in x and y directions to generate different object views (depicted here with an example of human face object 510). A subset of views 520 from all objects can be selected and presented to the ANN 200. Sample tuning properties 530 can be learned by the ANN 200 include single views and superpositions of multiple views. In this instance two groups of cells 540 emerge from the response of the ANN 200 to the inputted views 520. One group of cells 540a is specific to the object identity while the other group of cells 540b is specific to the direction and angle of rotation. The output of cells 540a and 540b can be used to identify the object and its rotation, as shown in the columns of the output grid in FIG. 5C.

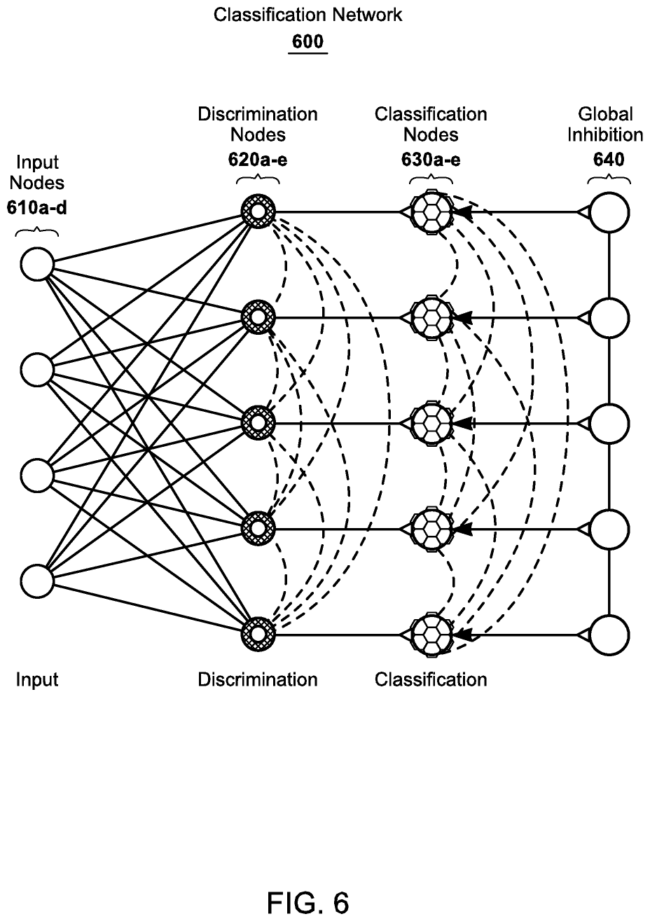

FIG. 6 is a diagram of classification network 600 comprising a bi-layer ANN connected to a classification layer in accordance with certain embodiments. The first two layers of classification network 600 function in the same manner as the two layers of the bi-layer ANN 200 above. The classification network 600 comprises a first layer of input nodes 610a-d (or first layer nodes), a second layer of discrimination nodes 620a-e (or representation or second layer nodes), and a third layer of classification nodes 630a-e (or third layer nodes). Nodes 630a-e in the classification layer can receive direct excitatory input from a single node in the discrimination layer (nodes 620a-e) while also receiving in parallel feedforward inhibitions that mirror the excitatory input from nodes in the input layer (input nodes 610a-d). The nodes in the classification layer 630a-e can also have recurrent excitatory connections and receive a global inhibitory signal 640 imposed on all nodes in the classification layer 630a-e (which helps limit spurious and/or runaway activities in this layer).

In certain embodiments, the global inhibition 640 is a constant. The value for global inhibition 640 can be any value capable of preventing runaway behavior in the nodes 630a-e of the classification layer. For example, the global inhibition 640 can be a constant, such as 10. This value can be set based on the expected inputs to the classification nodes 630a-e. The excitatory connections between each of the nodes in the discrimination layer 620 and its corresponding node in the classification layer 630 can be a constant, such as 1. The inhibitory weights for the connections between the nodes in the input layer 610a-d and the nodes in the classification layer 630a-e can also be a constant.

In certain embodiments, the number of nodes in the discrimination layer 620a-e can equal the number of nodes in the classification layer 630a-e. In embodiments where there are less classification nodes 630 than there are discrimination nodes 620, nodes in each layer can be associated with each other by grouping nodes in each layer and relating those nodes to a group of nodes in the other layer. For instance, in a classification network 600 where there are twice as many nodes in the discrimination layer 620 than there are in the classification layer 630, each node in the classification layer 630 can be connected to two nodes in the discrimination layer 620.

Learning in the classification network 600 can also be based on local learning rules. Learning for the first two layers (the input layer 610a-e and the discrimination layer 620a-e) can be accomplished using the same technique described above with respect to the bi-layer ANN 200. The node(s) in the third layer (the classification layer 630a-e) are augmented when a node in the discrimination layer 620a-e and the classification layer 630a-e are active at the same time or when two nodes in the classification layer 630a-e are active at the same time. In certain embodiments, the weights between to the nodes in the classification layer 630a-e and the input nodes 610a-d and the weights from the global inhibition do not change.

In certain embodiments, the classification network 600 is designed using principles of Maximal Dependence Capturing (MDC), which prescribes that individual nodes (neurons) should capture maximum information about distinct objects. To achieve this goal, the classification network 600 is designed to be able to differentiate objects in its initial response. To accomplish this, the weights between the input layer input nodes 610a-d and the discrimination layer nodes 620a-e are calibrated to allow distinct inputs to elicit disparate responses without specific learning. In certain embodiments, the initial bias in the connectivity is set to minimize the chances of co-activating any two of the discrimination nodes 630a-e at the same time, which maximizes distinctions in the classification network's 600 initial response to various inputs. For example, the connectivity matrix 4), which is the matrix of weights between each node of the input layer 610a-eand each node of the discrimination layer 620a-e, can be set so that the variance-covariance matrix of the response profiles of nodes in the representation layer match the identity matrix.

In certain embodiments, the nodes in the discrimination layer 620a-e are modeled as leaky integrate and fire neurons with thresholding. For example, the nodes in the discrimination layers 620a-e can have a dynamic response based on the following equation:

$$\frac{d \hat{x}}{d \hat{y}} = {ϕ}^{T} \hat{y} - \hat{x} - w {\hat{x}}^{th} ;$$

$${\hat{x}}^{th} = T ( \hat{x} ) ;$$

where \hat{x} is the response vector for the nodes in the discrimination layer, ŷ is the input vector to the layer, and the operator T(.) is the thresholding function (ReLU) that gives rise to \hat{x}^{th}, the thresholding activity.

The dynamic response of the nodes in the classification layer 630a-e can function in the same way as the nodes in the discrimination layer 620a-e with two primary differences. The input to each node in the classification layer (to each of classification nodes 630a-e) has two components, the excitatory input from the node in the discrimination layer 620a-e and the inhibitory input from the input layer input nodes 610a-d (which can be weighted inhibitory input from a single node of the input nodes 610a-d or from some combination of the input nodes 610a-d). Moreover, the inhibitory recurrent connection matrix w is changed to recurrent connection matrix in the classification layer w^{class}, which is equal to w^{class inhib} minus w^{class excit}. The effective layer dynamics for the classification layer 630a-e can be modelled by the following equation:

$$\frac{d {\hat{x}}_{class}}{dt} = {ϕ}^{T} \hat{y} - {ϕ}_{0}^{T} \hat{y} - {\hat{x}}_{class} - {w}^{class} {\hat{x}}_{class}^{th} ;$$

$${\hat{x}}_{class}^{th} = T ( {\hat{x}}_{class} ) .$$

Here ϕ^{T} ŷ is the signal from the nodes in the discrimination layer, and ϕ₀^{T} ŷ is the signal from the nodes in the input layer 610a-d.

The classification network 600 can update the connections from the nodes in the input layer 610a-d to optimize the following equation: E=∥ŷ−ϕ\hat{x}∥² where ŷ is an input vector, \hat{x} is the representational vector in the discrimination layer 620a-e, and ϕ is the matrix of the weights between the nodes in the input layer 610a-d and the nodes in the discrimination layer 620a-e. The updates in the connectivity for this function can be stated as Δϕ=α(ŷ \hat{x}^{T}−ϕ\hat{x} \hat{x}^{T}) where a is the learning rate. The recurrent inhibiting weights w in the discrimination layer 620a-e can be set using the following equation: w=(ϕ+Δϕ)^{T}(ϕ+Δϕ). In certain embodiments, there is no normalization of ϕ before calculating the recurrent weights.

In the classification network 600, the weights between nodes in the discrimination layer 620a-e and the nodes in the classification layer 630a-e can be updated based on the activities of the relevant two nodes. The recurrent excitatory connections between the nodes within the classification layer 630a-e can initially be set at 0, while all of the nodes in this layer receive global inhibition. The weights can then be updated based on the sum of potentiation between any pair of classification nodes 630a-e. For instance, when two nodes are co-active together, the potentiation for their connection increases. Alternatively, if only one of the two nodes is active at a set time, then the potentiation of their connection decreases. Finally, if both nodes remain inactive at a certain time, then the potentiation for their connection is unchanged. The change in potentiation, Δpᵢⱼ, between any two nodes i and j of the classification nodes 630a-e can be represented as follows: Δpᵢⱼ=1 when i=1 and j=1; Δpᵢⱼ=−1 when i=1 and j=0 or i=0 and j=1; Δpᵢⱼ=0 when i=0 and j=0. The connection weight between any two nodes in the classification layer (classification nodes 630a-e) is set to 1 if the sum of all potentials after encountering an arbitrary number of inputs reaches a preset threshold. All other weights remain 0. The potentiation values of all possible connections are reset to zero and the process of updating them restarts. Another way of expressing this updating of weights is with the following equation:

wᵢⱼ^{class}=1; Σₜ Δpᵢⱼ≥threshold; pᵢⱼ=0 ∀i, j.

The representation function of the classification network 600 maximizes differences between objects 135 and represents them distinctively. For classification, the classification network 600 can capture shared features that identify an object 135 in different perspectives, or a class. In the classification network 600, the distinguishing features of the same type of objects 135 can be linked together using mutual excitation and discerned from similar features of other categories using inhibition. In vertebrate brains, recurrent excitation and broad inhibition are prevalent in the upper layers of sensory cortices. The design of the classification network 600 draws inspiration from these biological systems by adding a recurrent layer, the classification layer 630 (a third layer), to simulate these circuit motifs and perform computations for classification. Nodes in this layer receive direct excitatory input from the discrimination layer 620 (the second layer) in a column-like, one-to-one manner. In parallel, they receive feedforward inhibitions that mirror the excitatory input from the input layer 610. The nodes in the classification layer 630 can also have recurrent excitatory connections between each other and receive global inhibition imposed on all nodes of this layer. The connections between classification nodes 630a-e and classification nodes 630a-e discrimination nodes 620a-e can also be adaptive. For example, the learning rule is that the connections strengthen between two excitatory nodes (discrimination to classification and between classification neurons, or nodes) when both are active. There is no weight change to connections to and from inhibitory neurons (or nodes).

This architectural configuration of the classification network 600 permits capturing class-specific features from objects 135. First, nodes in the classification layer 630 receive excitatory input from the discrimination layer 620 and feedforward inhibition relayed from the input layer 610. This combination passes the difference between the updated excitatory output and non-updated inhibitory output to inform the classification layer 630 about the features learned in the discrimination layer 620. Then, the lateral excitatory connection between the classification nodes 630a-e links the correlated features that provide the class information. Finally, global inhibition 640 ensures that only nodes receiving sufficient excitatory input can be active to reduce spurious and runaway activities. The result is that any of the classification nodes 630a-e with reciprocal excitation display attractor-like activities for class-specific features.

The classification abilities of the classification network 600 are superior to traditional approaches. For instance, when classifying objects in the MNIST handwritten digit dataset, training with only 25% of unlabeled samples results in the receptive fields of the classification network 600 resembling the digits in the discrimination layer 620. Further, population activities in the classification layer 630 of the classification network 600 exhibit high concordance for the same digit type but maintain distinction among different classes. The classification network 600 can correctly identify 94% of the digit types when using pooled nodes from the most consistently active nodes of each group. On the other hand, the most sophisticated existing network models currently achieve 85-99% accuracy, but they all need supervision in some form. For example, the self-supervised networks require digit labels in the initial training.

Like biological brains, the classification network 600 is robust in recognizing and categorizing individual symbols, faces, and handwritten digits without explicitly being designed for these tasks. Specifically, in its discrimination layer 620, the classification network 600 can identify features that uniquely identify an object 135 and, in the classification layer 630, link those features to form class-specific node ensembles. This last feature allows the classification network 600 to identify 3-dimensional objects 135, from views varying in size, position, and perspective. The problem of relating various views to extract the object's identity is particularly challenging. Various other neural network models require highly sophisticated algorithms with deep convolution layers and considerable supervision to achieve good performance. However to the classification network 600, different views of the same object form an image class that has shared features, which allows the classification network 600 to capture shared features of an image class without ostensibly being designed to do so. In other words, the classification network 600 can learn to consistently represent 3D objects 135 varying in size, position, and perspective.

The classification network 600 can identify objects 135 from various sizes and positions. For example, after experiencing several short clips of contiguous movie frames of objects 135 from various positions and sizes where random clips could be partially overlapped but covered less than 33% of the entire animation sequence in total, the classification network 600 can learn specific views and superpositions of different objects 135 in the input. When analyzing the entire animation sequence (much of which the classification network 600 had not experienced, >67% of all views), representations of different frames are distinct in the discrimination layer 620 and nodes are persistently active over large animation portions in the classification layer 630 (for all objects 135). Active node ensembles are specific for individual objects 135 even when there were high similarities between some of them. For the classification network 600, in the representation domain, the overall similarity between the same object's views are significantly higher than the similarity between images of distinct objects.

Producing representation invariant to 3D rotations is a challenging task for existing systems. However, for the classification network 600, classification nodes 630a-e can show consistent responses to the same object 135 regardless of the presentation angle, when presented with an animation of 3D rotation sequences with training of the classification network 600 on short clips of rotation along the vertical axis. This is true even for highly irregular shaped models. For example, with respect to inputs of four 4-legged animals, fluctuations in representations occurred at similar viewpoints, reflecting their common features. Overall, the similarity between the different perspectives of the same object is high but low between different objects for the classification network 600. Therefore, the classification network 600 is able to generate invariant identity representations even when the classification network 600 only experiences less than a third of all possible angles. Moreover, the classification 600 has the capacity for invariant representation and does not need to encounter all possible variations to represent objects 135 consistently.

The identity of an object 135 is embedded in the structural relationships among its features. These relationships, or dependencies, can be utilized to encode object identity. The classification network 600 maximally captures these dependencies to identify the presence of an object 135 without requiring accurate details of the input patterns. Here, the specific configurations of classification network 600 allow dependence capturing to permit invariant representations. This design is distinct from the hierarchical assembly model, which explains the increasing complexity of receptive field properties along the visual pathway and later formed the foundation of convolutional neural networks. These models assume that neurons in the cognitive centers recapitulate precise object details. However, accurate object image reconstruction is not necessary for robust representation, and this deeply rooted assumption can create unwanted complexity in modeling object recognition. The classification network 600 does not calculate reconstruction errors to assess its learning performance. By capturing dependencies that define objects 135 and their classes, it can produce remarkably consistent representations of the same object 135 across different conditions. The size, translation, and rotation invariance show that the classification network 600 can naturally link features that define an object or its class together without ostensibly being designed to do so. It can permit the non-linear transformation of the input signals into a representation geometry suitable for identification and discrimination.

The classification network 600 can illustrate how dependence capturing may learn about objects 135 through local and continuous changes at individual synapses and stably represent them (in a similar fashion to biological systems). The two circuit architectures are based on known connectivity patterns. Although both designs capture feature dependencies defining objects 135 and classes, their connections differ and serve different functions. The discrimination layer 620 makes individual representations as distinctive as possible. The classification layer 630 binds class-specific features to highlight and distinguish different object types. This two-prong representation may give rise to perceptual distances that are not linearly related to the distances in input space.

Although known networks show improved segregation between representations' projections in their final layers, they fail to recapitulate the projection straightening observed early in the sensory processing of biological systems. However the manifold structure of population response in the classification network 600, for rotating 3D objects, the low-dimensional manifolds in the input layer 610 are jagged and occupied convoluted subspaces. The geometry becomes more organized in the discrimination layer 620, with some example objects occupying curved or rugged spaces. Nearly all samples fall onto straightened hyperplane in the classification layer 630, consistent with their invariant representation by the nodes. With lower curvature indicating manifold straightening, the considerable linearization observed for all forms of variations in objects 135 and the transformation performed by the classification network 600 to straighten the manifolds allow perceptual invariance and robustness. This behavior conforms to recent theories that propose that the manifolds' geometry becomes more separable along the multiple sensory processing stages and gets straightened at later steps to allow invariant representations in biological systems.

The representation specificity assesses how specific an input's representation is. To estimate specificity, the pairwise similarity between all representations of all objects is calculated to obtain a similarity matrix S. The z-score of the similarity of an input's representation to all other representations is then calculated. In other words,

$${S}_{z} =. \frac{s . - mean ( s , dims = 1 )}{std ( s , dims = 1 )}$$

where mean(S, dims=1) and std(S, dims=1) denote the mean and standard deviation in the rows of the matrix S, and the dot operation (.) denotes elementwise calculations. The specificity of an input's representation was its z-scored similarity with itself i.e. Specificity =log₂(1.+diag(S_{z})).

To estimate the level of noise in images 130 and their features learned by the classification network 600, a power spectrum analysis can be performed. Both the images 130 and learned images can be Fourier-transformed, and their log-power calculated. The 2D log-power of the images 130 and the learned structures can be radially averaged to obtain the 1D power spectrum. The presence of noise is indicated by a higher power in higher frequencies of the spectrum. The comparisons can be made using the highest 20% of the frequencies.

The representation of different views of 3D objects in the classification layer 630a-e consisted of nodes that are consistently active for all views of the object. The overall consistency of object representation in the classification layer 630a-e of the classification network 600 can be calculated. To calculate the consistency, the cosine similarity between the representations of consecutive views of the object 135 can be measured. The variation in the similarity indicates the consistency in representations. A lower variation in the similarity measures implies higher consistency and vice versa.

To assess the geometry of manifold structures, all views of all objects 135 in the matrix I can be collected. Similarly, their representations from discrimination layer 620a-e and classification layer 630a-e in matrices R_{d} and R_{c} respectively can be collected. Principal component analysis can be performed on all three matrices separately and all views of individual objects plotted as projections on the first two principal components. The plot depicts a 2D projection of the object manifolds. To calculate the curvature of the 2D projection of the manifold, three consecutive points p, pᵢ₊₁ and pᵢ₊₂ are selected. The angle between vectors points p, pᵢ₊₁ and pᵢ₊₂ can be calculated using the following equation:

$${θ}_{i} = {cos}^{- 1} ( \frac{( {p}_{i + 2} - {p}_{i + 1} ) \cdot ( {p}_{1 + 1} - {p}_{i} )}{‖ {p}_{i + 2} - {p}_{i + 1} ‖ ‖ {p}_{1 + 1} - {p}_{i} ‖} ) .$$

These angles can be measured for all possible values of i. The curvature of the manifold can be calculated as the average of all angle measures.

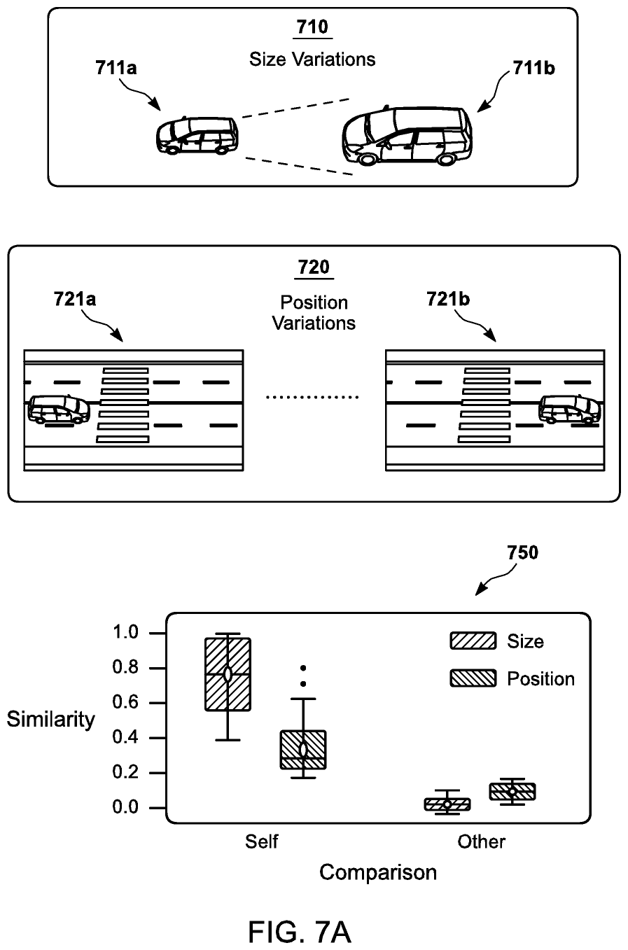

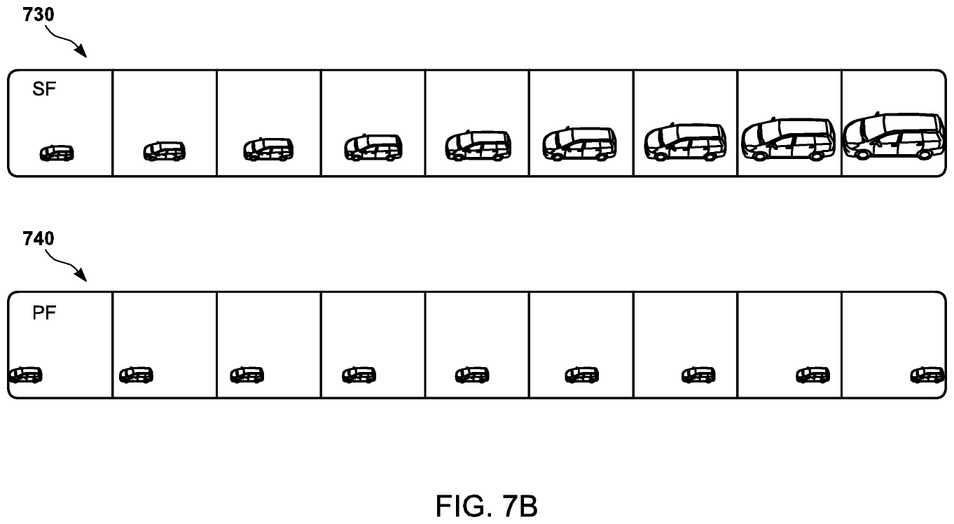

FIG. 7 is an illustrating demonstrating how characteristics of an object 135, varying views of which are inputted, are captured in the output for a classification network 600 in accordance with certain embodiments. Animations were rendered as movie frames depicting the size variations (SF) 730 and position variations (PF) 740. Examples of different position variations 721a and 721b are shown for a car on a road in box 720. Examples of size variation for minivan (711a and 711b) are shown in box 710. Short sequences of these frames 730 and 740 generally not covering more than 33% of the entire sequences of size variation frames 730 and position variation frames 740 in total can be randomly selected and fed into the classification network 600. In the discrimination layer 620, the classification network 600 can capture complete object shapes varying in sizes and positions. Chart 750 comparing similarity scores between the same objects and between different objects shows that the average similarities between representations of frames belonging to the same object (self) are considerably higher than the representation similarities between frames of distinct objects (other).

Inputted images 130 to the neural network architecture 140 can include any number of pixels, such as 100×100 pixels. The number of discrimination layer 620 nodes and classification nodes 630 (when used) can vary. For example, the number of discrimination layer 620 nodes and classification nodes 630 can vary depending on the pixel number of the inputs to the neural network architecture 140. For instance, where the inputs are 100×100 pixels, the number of nodes in the discrimination layer 620 can be 500 or 1000.In certain embodiments where the images inputted are 16×16 (in pixels), discrimination layer 620 size can be 500 nodes. In certain embodiments where the input images are 28×28 (in pixels), the discrimination layer 620 and classification layers 630 both include 10,000 nodes. When object views are 100×100 pixels, the sizes (both in the classification layer 620 and discrimination layer 630) can be 1,000, 10,000, or more. Alternatively, the classification 630 and discrimination 620 layers may have the same or more nodes than the input layer 610. For example, in the classification network 600, the input layer 610 can have 784 nodes and the classification 620 and discrimination 630 layers can each have 10,000 nodes.

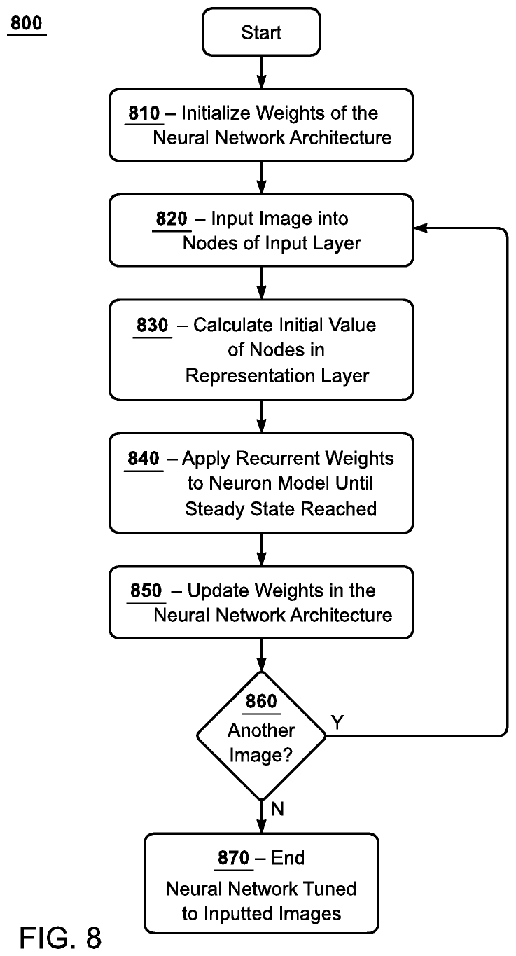

FIG. 8 illustrates a flow chart for an exemplary method 800, according to certain embodiments. Method 800 is merely exemplary and is not limited to the embodiments presented herein. Method 800 can be employed in many different embodiments or examples not specifically depicted or described herein. In some embodiments, the steps of method 800 can be performed in the order presented. In other embodiments, the activities of method 800 can be performed in any suitable order. In still other embodiments, one or more of the steps of method 800 can be combined or skipped. In many embodiments, system 100 and/or computer vision system 150 can be configured to perform method 800 and/or one or more of the steps of method 800. In these or other embodiments, one or more of the steps of method 800 can be implemented as one or more computer instructions configured to run at one or more processing devices 201 and configured to be stored at one or more non-transitory computer storage devices 202. Such non-transitory memory storage devices 202 can be part of a computer system such as system 100 and/or computer vision system 150. The processing device(s) 201 can be similar or identical to the processing device(s) 201 described above with respect to computer system 100 and/or computer vision system 150.

In step 810, the weights between the input layer of the neural network architecture and the recurrent weights between the nodes in the representation layer are initialized. The manner in which the weights are initialized can vary. In certain embodiments, the initial weights between the nodes in the input layer and the nodes in the representation layer can be calculated based on the eigenvectors of the variance-covariance matrix of the inputs. The weights of the connections between the nodes of the representation layer can be calculated using the following formula: S=−(W^{T}W−I).

In step 820, an image included in an input sequence is input into the nodes of the input layer. In embodiments where the image is comprised of pixels, each pixel can be input into a separate node. In other words, the number of input nodes is equal to the number of pixels in the images of the data set to be analyzed. In certain embodiments, the pixels are input into the input layer without being preprocessed, thereby giving that input node the value of that pixel. Alternatively, the images in the data set may be preprocessed. For example, the values of each image may be scaled in a certain, such as by scaling all image values to be within a certain range (such as from 0 to 1). Certain transforms, such as the Fourier transform or a wavelet transform, can be performed on the image before inputting the image data into the nodes of the input layer.

In step 830, initial values of the nodes included in the representation layer are calculated by multiplying the vector of values of the nodes of the input layer for in step 820 by the matrix of weights for the connections in the neural network architecture between the nodes in the input layer and the nodes in the representation layer. The first time step 830 is performed, these weights are the initial weights of the ANN, which were calculated in step 810. As additional images are iteratively process, these weights are updated in accordance with step 850 below.

In step 840, a behavior model for the nodes in the representation layer is applied to calculate the values for the nodes in the representation layer. Various types of behavior models can be used, including those models drawn from biological neural networks. For example, the behavior of the nodes in representation layer of the ANN can be modeled as “Leaky Integrate-and-Fire” neurons. As part of the step 840, the values from the recurrent connections between the nodes in the representation layer can be used to calculate the values of the nodes in the representation layer. The calculation of the values of the nodes can be performed iteratively, until the values for each nodes reaches a steady state.

In embodiments where the neural network architecture corresponds to a classification network with a third layer of nodes, the values of the nodes in the classification layer can be updated by applying the process for the behavioral model as discussed in the paragraph above. For example, the initial values of the nodes in the classification layer can be calculated, for each node by summing: a) the value of the input (multiplied by an excitatory connection weight) from the node in the discrimination (or representation layer), b) the value of the input (multiplied by inhibitory connection weights) from the node(s) in the input layer, and c) the value of a global inhibition applied to all nodes in the classification layer.

In neural network architectures having a classification layer, the number of times that any two nodes in the classification layer are active together can be tracked over a given number of inputs. If the number of times any two nodes are active together is above a certain threshold, the weight between those nodes can be set to an excitatory value (such as 1). The weights of connections between nodes in the classification layer that are not typically active together (as determined by being below the threshold), can be set to 0.

In step 850, the weights between the nodes in the neural network architecture are updated. In certain embodiments, the updating of the weight matrix for the connections between the nodes in the input layer and the nodes in the representation layer is performed using a gradient descent approach. The recurrent weights in the representation layer are then updated based on the weights between the nodes in the input layer and nodes in the representation layer using the following formula: S=−(W^{T}W−I).

In step 860, it is determined whether there is another image in the data set. If not, the method 800 terminates. If so, the method 800 returns to step 820.

In step 870, the method 800 terminates with the neural network architecture tuned to inputted the images.

In certain embodiments, the data to be inputted into the neural network architecture 140 is not picture or visual data. For example, the data to be analyzed can be DNA or RNA sequences, audio data, or other sensory data. This data can be ‘pixelated’ or transformed in another manner so that it can be inputted into the input layer of the neural network architecture 140.

The neural network architecture 140 has advantages over other known neural networks. The neural network architecture 140 utilizes fundamentally different learning algorithms from existing models and do not rely on error propagation. It can also avoid the problem of credit assignments in deep learning. It can produce remarkable results that rival much more complicated networks with fewer nodes, fewer parameters, and no requirement for deep layers. Although this performance may be trumped by the highly sophisticated deep learning models that rely on superior computing power, the neural network architecture 140 can also be developed into complex structures to perform additional tasks with improved performance. Given that it requires far fewer examples to learn and is much more energy efficient, the neural network architecture 140 can rival or outperform current alternatives.

As evidenced by the disclosure herein, the inventive techniques set forth in this disclosure are rooted in computer technologies that overcome existing problems in known computer vision systems, including problems dealing with extracting robust object representations from images and/or performing computing vision functions. The techniques described in this disclosure provide a technical solution (e.g., one that utilizes various Al-based neural networking and machine learning techniques) for overcoming the limitations associated with known techniques. This technology-based solution marks an improvement over existing capabilities and functionalities related to computer vision and machine learning systems by improving the accuracy of the computer vision (or machine learning) functions and reducing the information that is required to perform such functions. Further, because no storage of reference objects (such as faces or facial objects) is required in certain embodiments, this can serve to minimize storage requirements and avoid privacy issues. Moreover, the neural network architectures disclosed herein are less complex, and therefore less computationally intensive, than other neural networks. They further do not require time- and resource-intensive creation and labeling of training set data.

Additionally, the neural network architectures described herein can additionally provide advantages of being fully interpretable (so-called white box) and of not being subject to neural network's commonly observed “catastrophic forgetting”. These findings have substantial implications for understanding how biological brains achieve invariant object representation and for developing biologically realistic intelligent networks that are efficient and robust.

In certain embodiments, a system for extracting object representations from images comprises one or more processing devices; one or more non-transitory computer-readable storage devices storing computing instructions configured to be executed on the one or more processing devices and cause the one or more processing devices to execute functions comprising: receiving, at a computing device, an image comprising pixels; and generating, at the computing device, an object representation from the image using a bi-layer neural network comprising an input layer of input nodes and a representation layer of representation nodes; wherein: all input nodes are connected to all representation nodes through a first set of weighted connections having differing values and all representation nodes are connected to all other representation nodes through a second set of weighted connections having differing values; a first set of connection weights associated with the first set of weighted connections between the input nodes of the input layer and the representation nodes of the representation layer is selected to minimize the chances that two representation nodes in the representation layer are active at the same time; a second set of connection weights for the second set of weighted connections is determined such that weights between any two representation nodes in the representation layer are the same in both directions; the input nodes of the input layer receive a first set of values, each of which relates to one of the pixels of the image; a second set of values for the representation nodes in the representation layer is calculated based, at least in part, on inputs received via the first set of weighted connections between the input nodes and the representation nodes and the second set of weighted connections among the representation nodes; and the second set of values for the representation nodes in the representation layer is utilized to generate the object representation for the image.

In certain embodiments, the first set of connection weights associated with the first set of weighted connections is calculated using estimates of the eigenvectors of the variance-covariance matrix based on an input matrix created from vector representations of the images.

In certain embodiments, a learning mechanism continuously updates the first set of connection weights as additional images are processed by the bi-layer neural network.

In certain embodiments, the learning mechanism includes a stochastic gradient descent method.

In certain embodiments, the second set of values for the representation nodes in the representation layer and the first set of values for the input nodes in the input layer are all non-negative values.

In certain embodiments, the second set of connection weights for the second set of weighted connections is continuously updated based, at least in part, on changes in the first set of connection weights.

In certain embodiments, the object representations include data related to object identification and data related to position information.

In certain embodiments, the second set of weighted connections is inhibitory.

In certain embodiments, the stochastic gradient descent method uses a step with a step size between 0 and 1.

In certain embodiments, a method for extracting object representations from images implemented via execution of computing instructions configured to run at one or more processing devices and configured to be stored on non-transitory computer-readable media, the method comprises: receiving, at a computing device, an image comprising pixels; and generating, at the computing device, an object representation from the image using a bi-layer neural network comprising an input layer of input nodes and a representation layer of representation nodes; wherein: all input nodes are connected to all representation nodes through a first set of weighted connections having differing values and all representation nodes are connected to all other representation nodes through a second set of weighted connections having differing values; a first set of connection weights associated with the first set of weighted connections between the input nodes of the input layer and the representation nodes of the representation layer is selected to minimize the chances that two representation nodes in the representation layer are active at the same time; a second set of connection weights for the second set of weighted connections is determined such that weights between any two representation nodes in the representation layer are the same in both directions; the input nodes of the input layer receive a first set of values, each of which relates to one of the pixels of the image; a second set of values for the representation nodes in the representation layer is calculated based, at least in part, on inputs received via the first set of weighted connections between the input nodes and the representation nodes and the second set of weighted connections among the representation nodes; and the second set of values for the representation nodes in the representation layer is utilized to generate the object representation for the image.

In certain embodiments, the first set of connection weights associated with the first set of weighted connections is calculated using estimates of the eigenvectors of the variance-covariance matrix based on an input matrix created from vector representations of the images.

In certain embodiments, a learning mechanism continuously updates the first set of connection weights as additional images are processed by the bi-layer neural network.

In certain embodiments, the learning mechanism includes a stochastic gradient descent method.

In certain embodiments, the second set of values for the representation nodes in the representation layer and the first set of values for the input nodes in the input layer are all non-negative values.

In certain embodiments, the bi-layer neural network includes more representation nodes in the representation layer than input nodes in the input layer.

In certain embodiments, the second set of connection weights for the second set of weighted connections is continuously updated based, at least in part, on changes in the first set of connection weights.

In certain embodiments, the object representations include data related to object identification and data related to position information.

In certain embodiments, the second set of weighted connections is inhibitory.

In certain embodiments, a computer program product for extracting object representations from images, the computer program product comprising a non-transitory computer-readable medium including instructions for causing a computing device to: receive, at a computing device, an image comprising pixels; and generate, at the computing device, an object representation from the image using a bi-layer neural network comprising an input layer of input nodes and a representation layer of representation nodes; wherein: all input nodes are connected to all representation nodes through a first set of weighted connections having differing values and all representation nodes are connected to all other representation nodes through a second set of weighted connections having differing values; a first set of connection weights associated with the first set of weighted connections between the input nodes of the input layer and the representation nodes of the representation layer is selected to minimize the chances that two representation nodes in the representation layer are active at the same time; a second set of connection weights for the second set of weighted connections is determined such that weights between any two representation nodes in the representation layer are the same in both directions; the input nodes of the input layer receive a first set of values, each of which relates to one of the pixels of the image; a second set of values for the representation nodes in the representation layer is calculated based, at least in part, on inputs received via the first set of weighted connections between the input nodes and the representation nodes and the second set of weighted connections among the representation nodes; and the second set of values for the representation nodes in the representation layer is utilized to generate the object representation for the image.

In certain embodiments, the first set of connection weights associated with the first set of weighted connections is calculated using estimates of the eigenvectors of the variance-covariance matrix based on an input matrix created from vector representations of the images.

In certain embodiments, a system for classifying object representations from images comprises: one or more processing devices; one or more non-transitory computer readable storage devices storing computing instructions configured to be executed on the one or more processing devices and cause the one or more processing devices to execute functions comprising: receiving, at a computing device, an image comprising pixels; and generating, at the computing device, classification data for one or more objects in the image using a tri-layer neural network comprising: i) an input layer comprising input nodes; ii) a representation layer comprising representation nodes; and iii) a classification layer comprising classification nodes; wherein: all input nodes are connected to all representation nodes through a first set of weighted connections having differing values and all representation nodes are connected to all other representation nodes through a second set of weighted connections having differing values; a first set of connection weights associated with the first set of weighted connections between the input nodes of the input layer and the representation nodes of the representation layer is selected to minimize the chances that two representation nodes in the representation layer are active at the same time a second set of connection weights for the second set of weighted connections is determined such that the connection weights between any two representation nodes in the representation layer are the same in both directions; the classification nodes of the classification layer are connected to the representation nodes of the representation layer in a one-to-one excitatory manner and to the input nodes of the input layer in a one-to-one inhibitory manner; the classification nodes of the classification layer are connected to each other through a third set of weighted connections such that the connection weights between any two classification nodes in the classification layer are the same in both directions; the classification nodes of the classification layer receive a global inhibitory input; the input nodes of the input layer receive a first set of values, each of which relates to one of the pixels of the image; a second set of values for the representation nodes in the representation layer is calculated based, at least in part, on inputs received via the first set of weighted connections between the input nodes and the representation nodes and the second set of weighted connections among the representation nodes; a third set of values for the classification nodes in the classification layer is calculated based, at least in part, on inputs received by the classification nodes from the input nodes, the representation nodes and other classification nodes; and the classification data for the one or more objects in the image is generated based, at least in part, on the third set of values.

In certain embodiments, the first set of connection weights associated with the first set of weighted connections is calculated using estimates of the eigenvectors of the variance-covariance matrix based on an input matrix created from vector representations of the images.

In certain embodiments, a learning mechanism continuously updates the first set of connection weights as additional images are processed by the tri-layer neural network.

In certain embodiments, the learning mechanism includes a stochastic gradient descent method.

In certain embodiments, the third set of values for the classification nodes in the classification layer and the second set of values for the representation nodes in the representation layer and the first set of values for the input nodes in the input layer are all non-negative values.

In certain embodiments, the second set of connection weights for the second set of weighted connections is continuously updated based, at least in part, on changes in the first set of connection weights.

In certain embodiments, the classification data comprises identification data related to at least one object in the images.

In certain embodiments, the second set of weighted connections is inhibitory.

In certain embodiments, the stochastic gradient descent method uses a step with a step size between 0 and 1.

In certain embodiments, a method for classifying object representations from images implemented via execution of computing instructions configured to run at one or more processing devices and configured to be stored on non-transitory computer-readable media, the method comprising: receiving, at a computing device, an image comprising pixels; and generating, at the computing device, classification data for one or more objects in the image using a tri-layer neural network comprising: i) an input layer comprising input nodes; ii) a representation layer comprising representation nodes; and iii) a classification layer comprising classification nodes; wherein: all input nodes are connected to all representation nodes through a first set of weighted connections having differing values and all representation nodes are connected to all other representation nodes through a second set of weighted connections having differing values; a first set of connection weights associated with the first set of weighted connections between the input nodes of the input layer and the representation nodes of the representation layer is selected to minimize the chances that two representation nodes in the representation layer are active at the same time; a second set of connection weights for the second set of weighted connections is determined such that the connection weights between any two representation nodes in the representation layer are the same in both directions; the classification nodes of the classification layer are connected to the discrimination nodes of the discrimination layer in a one-to-one excitatory manner and to the input nodes of the input layer in a one-to-one inhibitory manner; the classification nodes of the classification layer are connected to each other through a third set of weighted connections such that the connection weights between any two classification nodes in the classification layer are the same in both directions; the classification nodes of the classification layer receive a global inhibitory input; the input nodes of the input layer receive a first set of values, each of which relates to one of the pixels of the image; a second set of values for the representation nodes in the representation layer is calculated based, at least in part, on inputs received via the first set of weighted connections between the input nodes and the representation nodes and the second set of weighted connections among the representation nodes; a third set of values for the classification nodes in the classification layer is calculated based, at least in part, on inputs received by the classification nodes from the input nodes, the representation nodes and other classification nodes; and the classification data for the one or more objects in the image is generated based, at least in part, on the third set of values.

In certain embodiments, the first set of connection weights associated with the first set of weighted connections is calculated using estimates of the eigenvectors of the variance-covariance matrix based on an input matrix created from vector representations of the images.

In certain embodiments, a learning mechanism continuously updates the first set of connection weights as additional images are processed by the tri-layer neural network.

In certain embodiments, the learning mechanism includes a stochastic gradient descent method.

In certain embodiments, the third set of values for the classification nodes in the classification layer, the second set of values for the representation nodes in the representation layer, and the first set of values for the input nodes in the input layer are all non-negative values.

In certain embodiments, the second set of connection weights for the second set of weighted connections is continuously updated based, at least in part, on changes in the first set of connection weights.

In certain embodiments, the classification data comprises identification data related to at least one object in the images.

In certain embodiments, the second set of weighted connections is inhibitory.

In certain embodiments, the stochastic gradient descent method uses a step with a step size between 0 and 1.

In certain embodiments, a computer program product for classifying object representations from images, the computer program product comprises a non-transitory computer-readable medium including instructions for causing a computing device to: receive, at a computing device, an image comprising pixels; and generate, at the computing device, classification data for one or more objects in the image using a tri-layer neural network comprising: i) an input layer comprising input nodes; ii) a representation layer comprising representation nodes; and iii) a classification layer comprising classification nodes; wherein: all input nodes are connected to all representation nodes through a first set of weighted connections having differing values and all representation nodes are connected to all other representation nodes through a second set of weighted connections having differing values; a first set of connection weights associated with the first set of weighted connections between the input nodes of the input layer and the representation nodes of the representation layer is selected to minimize the chances that two representation nodes in the representation layer are active at the same time; a second set of connection weights for the second set of weighted connections is determined such that the connection weights between any two representation nodes in the representation layer are the same in both directions; the classification nodes of the classification layer are connected to the discrimination nodes of the discrimination layer in a one-to-one excitatory manner and to the input nodes of the input layer in a one-to-one inhibitory manner; the classification nodes of the classification layer are connected to each other through a third set of weighted connections such that the connection weights between any two classification nodes in the classification layer are the same in both directions; the classification nodes of the classification layer receive a global inhibitory input; the input nodes of the input layer receive a first set of values, each of which relates to one of the pixels of the image; a second set of values for the representation nodes in the representation layer is calculated based, at least in part, on inputs received via the first set of weighted connections between the input nodes and the representation nodes and the second set of weighted connections among the representation nodes; a third set of values for the classification nodes in the classification layer is calculated based, at least in part, on inputs received by the classification nodes from the input nodes, the representation nodes and other classification nodes; and the classification data for the one or more objects in the image is generated based, at least in part, on the third set of values.

In certain embodiments, the first set of connection weights associated with the first set of weighted connections is calculated using estimates of the eigenvectors of the variance-covariance matrix based on an input matrix created from vector representations of the images.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium, such as a semiconductor or solid-state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components is for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

1. A system for extracting object representations from images comprising:
one or more processing devices;
one or more non-transitory computer-readable storage devices storing computing instructions configured to be executed on the one or more processing devices and cause the one or more processing devices to execute functions comprising:
receiving, at a computing device, an image comprising pixels; and
generating, at the computing device, an object representation from the image using a bi-layer neural network comprising an input layer of input nodes and a representation layer of representation nodes;
wherein:
all input nodes are connected to all representation nodes through a first set of weighted connections having differing values and all representation nodes are connected to all other representation nodes through a second set of weighted connections having differing values;
a first set of connection weights associated with the first set of weighted connections between the input nodes of the input layer and the representation nodes of the representation layer is selected to minimize the chances that two representation nodes in the representation layer are active at the same time;
a second set of connection weights for the second set of weighted connections is determined such that weights between any two representation nodes in the representation layer are the same in both directions;
the input nodes of the input layer receive a first set of values, each of which relates to one of the pixels of the image;
a second set of values for the representation nodes in the representation layer is calculated based, at least in part, on inputs received via the first set of weighted connections between the input nodes and the representation nodes and the second set of weighted connections among the representation nodes; and
the second set of values for the representation nodes in the representation layer is utilized to generate the object representation for the image.

2. The system of claim 1, wherein the first set of connection weights associated with the first set of weighted connections is calculated using estimates of the eigenvectors of the variance-covariance matrix based on an input matrix created from vector representations of the images.

3. The system of claim 1, wherein a learning mechanism continuously updates the first set of connection weights as additional images are processed by the bi-layer neural network.

4. The system of claim 3, wherein the learning mechanism includes a stochastic gradient descent method.

5. The system of claim 1, wherein the second set of values for the representation nodes in the representation layer and the first set of values for the input nodes in the input layer are all non-negative values.

6. The system of claim 1, wherein the second set of connection weights for the second set of weighted connections is continuously updated based, at least in part, on changes in the first set of connection weights.

7. The system of claim 1, wherein the object representations include data related to object identification and data related to position information.

8. The system of claim 1, wherein the second set of weighted connections is inhibitory.

9. The system of claim 4, wherein the stochastic gradient descent method uses a step with a step size between 0 and 1.

10. A method for extracting object representations from images implemented via execution of computing instructions configured to run at one or more processing devices and configured to be stored on non-transitory computer-readable media, the method comprising:
receiving, at a computing device, an image comprising pixels; and
generating, at the computing device, an object representation from the image using a bi-layer neural network comprising an input layer of input nodes and a representation layer of representation nodes;
wherein:
all input nodes are connected to all representation nodes through a first set of weighted connections having differing values and all representation nodes are connected to all other representation nodes through a second set of weighted connections having differing values;
a first set of connection weights associated with the first set of weighted connections between the input nodes of the input layer and the representation nodes of the representation layer is selected to minimize the chances that two representation nodes in the representation layer are active at the same time;
a second set of connection weights for the second set of weighted connections is determined such that weights between any two representation nodes in the representation layer are the same in both directions;
the input nodes of the input layer receive a first set of values, each of which relates to one of the pixels of the image;
a second set of values for the representation nodes in the representation layer is calculated based, at least in part, on inputs received via the first set of weighted connections between the input nodes and the representation nodes and the second set of weighted connections among the representation nodes; and
the second set of values for the representation nodes in the representation layer is utilized to generate the object representation for the image.

11. The method of claim 10, wherein the first set of connection weights associated with the first set of weighted connections is calculated using estimates of the eigenvectors of the variance-covariance matrix based on an input matrix created from vector representations of the images.

12. The method of claim 10, wherein a learning mechanism continuously updates the first set of connection weights as additional images are processed by the bi-layer neural network.

13. The method of claim 12, wherein the learning mechanism includes a stochastic gradient descent method.

14. The method of claim 10, wherein the second set of values for the representation nodes in the representation layer and the first set of values for the input nodes in the input layer are all non-negative values.

15. The method of claim 10, wherein the bi-layer neural network includes more representation nodes in the representation layer than input nodes in the input layer.

16. The method of claim 10, wherein the second set of connection weights for the second set of weighted connections is continuously updated based, at least in part, on changes in the first set of connection weights.

17. The method of claim 10, wherein the object representations include data related to object identification and data related to position information.

18. The method of claim 1, wherein the second set of weighted connections is inhibitory.

19. A computer program product for extracting object representations from images, the computer program product comprising a non-transitory computer-readable medium including instructions for causing a computing device to:
receive, at a computing device, an image comprising pixels; and
generate, at the computing device, an object representation from the image using a bi-layer neural network comprising an input layer of input nodes and a representation layer of representation nodes;
wherein:
all input nodes are connected to all representation nodes through a first set of weighted connections having differing values and all representation nodes are connected to all other representation nodes through a second set of weighted connections having differing values;
a first set of connection weights associated with the first set of weighted connections between the input nodes of the input layer and the representation nodes of the representation layer is selected to minimize the chances that two representation nodes in the representation layer are active at the same time;
a second set of connection weights for the second set of weighted connections is determined such that weights between any two representation nodes in the representation layer are the same in both directions;
the input nodes of the input layer receive a first set of values, each of which relates to one of the pixels of the image;
a second set of values for the representation nodes in the representation layer is calculated based, at least in part, on inputs received via the first set of weighted connections between the input nodes and the representation nodes and the second set of weighted connections among the representation nodes; and
the second set of values for the representation nodes in the representation layer is utilized to generate the object representation for the image.

20. The computer program product of claim 19, wherein the first set of connection weights associated with the first set of weighted connections is calculated using estimates of the eigenvectors of the variance-covariance matrix based on an input matrix created from vector representations of the images.
